(19) United States
(12) Patent Application Publication
(10) Pub. No.: US 2025/0189629 A1
(43) Pub. Date: Jun. 12, 2025

(54) Providing Radar Sensing for Multiple Applications

(71) Applicant: Google LLC, Mountain View, CA (US)

(72) Inventors: Andrew Felch, Palo Alto, CA (US); Jaime Lien, Mountain View, CA (US); Oleksandr Paniutin, San Jose, CA (US)

(73) Assignee: Google LLC, Mountain View, CA (US)

(21) Appl. No.: 18/970,817

(22) Filed: Dec. 5, 2024

Related U.S. Application Data
(60) Provisional application No. 63/607,892, filed on Dec. 8, 2023.

(51) Int. Cl. G01S 7/40

(52) U.S. Cl. CPC G01S 7/4004

(57) ABSTRACT

Techniques and apparatuses are described that provide radar sensing for multiple applications. In an example aspect, middleware is coupled between multiple applications and a radar system. The middleware performs translation services, conflict resolution and/or resource management to configure the radar system in a manner that can provide radar sensing to at least a substantial subset of the applications during a given time interval. Also, the middleware can dynamically adjust the operation of the radar system as different applications request radar sensing. The middleware enables the radar system to provide radar sensing for a larger quantity of diverse applications without integrating additional radar systems into the computing device and/or without the applications needing to communicate and/or negotiate with each other. In this way, the middleware can expand the utilization of the radar system, thereby providing additional features to enhance the user experience.

### CROSS-REFERENCE TO RELATED APPLICATION(S)

This application claims the benefit of U.S. Provisional Patent Application Ser. No. 63/607,892, filed on Dec. 8, 2023, the disclosure of which is incorporated by reference herein in its entirety.

### BACKGROUND

Radars are useful devices that can detect objects. Relative to other types of sensors, like a camera, a radar can provide improved performance in many different environmental conditions, such as low lighting and fog, or with moving or overlapping objects. Radar can also detect objects through one or more occlusions, such as a purse or a pocket.

A radar can be a complex piece of technology with particular tradeoff considerations made to realize a target performance. Example tradeoff considerations include detection range; range, Doppler, and angular resolution; range and Doppler ambiguities; sensitivity; false-alarm rate; reaction time; size; power consumption; and cost. Due to the complex design and operational considerations, radars are often customized for particular applications or use cases. For example, some radars provide navigational aid, others may map an environment, still others may assist a user interacting with an electronic device.

While radar can provide many advantages, it can be viewed as a black box by other external entities. These entities may be unaware of the complexities that enable the radar to achieve a target level of performance. As a result, it can be challenging for applications in an electronic device to take advantage of the features offered by radar. Furthermore, it can be challenging for the electronic device to provide radar sensing for multiple applications during a same time interval. Some applications, for instance, may need substantially different performance from the radar. Conflicts can therefore arise with multiple applications attempting to control an operation of the radar.

### SUMMARY

Techniques and apparatuses are described that provide radar sensing for multiple applications. In an example aspect, a computing device includes middleware, which is coupled between multiple applications and at least one radar system. The multiple applications can utilize radar sensing for a variety of different use cases. Some of the use cases may require different performance from the radar system. To support the multiple applications, the middleware can provide a variety of services, including translation, conflict resolution, resource management, or some combination thereof. With these services, the middleware configures a radar system in a manner that can provide radar sensing to at least a substantial subset of the applications during a given time interval. Furthermore, the middleware can dynamically adjust the operation of the radar system as different applications request radar sensing. The middleware enables the radar system to provide radar sensing for a larger quantity of diverse applications without integrating additional radar systems into the computing device and/or without the applications needing to communicate and/or negotiate with each other. In this way, the middleware can expand the utilization of the radar system, thereby providing additional features to enhance the user experience.

Aspects described below include a method performed by middleware. The method includes accepting a first request from a first application. The first request includes first radar-sensing performance requirements for a first radar-sensing use case provided by the first application. The method also includes accepting a second request from a second application. The second request includes second radar-sensing performance requirements for a second radar-sensing use case provided by the second application. The method further includes configuring a radar system to operate in accordance with one or more modes that satisfy the first and second radar-sensing performance requirements of the first and second requests.

Aspects described below also include a method performed by middleware that is coupled between a radar system and multiple applications. The method includes receiving multiple requests from the multiple applications. Each application of the multiple applications is capable of being in an active state or an inactive state with regard to utilizing radar sensing provided by the radar system. The method also includes dynamically configuring the radar system to operate in accordance with at least one mode to provide radar sensing for a set of the multiple applications that are in the active state. The at least one mode satisfies a set of the multiple requests that correspond with the set of the multiple applications.

Aspects described below include an apparatus comprising middleware configured to perform any of the described methods.

Aspects described below include a computer-readable storage medium comprising instructions that, responsive to execution by a processor, cause middleware to perform any of the described methods.

Aspects described below include a system with means for providing radar sensing for multiple applications.

### BRIEF DESCRIPTION OF DRAWINGS

Apparatuses for and techniques providing radar sensing for multiple applications are described with reference to the following drawings. The same numbers are used throughout the drawings to reference like features and components:

FIG. 1 illustrates example environments in which radar sensing can be provided;

FIG. 2-1 illustrates an example implementation of a radar system as part of a computing device;

FIG. 2-2 illustrates example positions of multiple radar systems on a smartphone.

FIG. 3-1 illustrates example operations of a radar system;

FIG. 3-2 illustrates an example radar framing structure for radar sensing;

FIG. 4 illustrates different types of radar framing structures for providing radar sensing for multiple applications;

FIG. 5-1 illustrates a first example in which a radar system operates in accordance with two modes for providing radar sensing for multiple applications;

FIG. 5-2 illustrates a second example in which a radar system operates in accordance with two modes for providing radar sensing for multiple applications;

FIG. 5-3 illustrates a third example in which a radar system operates in accordance with three modes for providing radar sensing for multiple applications;

FIG. 6 illustrates example middleware for providing radar sensing for multiple applications;

FIG. 7 illustrates an example scheme implemented by middleware for providing radar sensing for multiple applications;

FIG. 8 illustrates an example flow diagram for resolving conflicts between multiple applications;

FIG. 9 illustrates an example method performed by a radar system for providing radar sensing for multiple applications; and

FIG. 10 illustrates an example computing system embodying, or in which techniques may be implemented that enable use of, radar sensing for multiple applications.

### DETAILED DESCRIPTION

A radar can be a complex piece of technology with particular tradeoff considerations made to realize a target performance. Example tradeoff considerations include detection range; range, Doppler, and angular resolution; range and Doppler ambiguities; sensitivity; false-alarm rate; reaction time; size; power consumption; and cost. Due to the complex design and operational considerations, radars are often customized for particular applications or use cases. For example, some radars provide navigational aid, others may map an environment, still others may assist a user interacting with an electronic device.

While radar can provide many advantages, it can be viewed as a black box by other external entities. These entities may be unaware of the complexities that enable the radar to achieve a target level of performance. As a result, it can be challenging for applications in an electronic device to take advantage of the features offered by radar. Furthermore, it can be challenging for the electronic device to provide radar sensing for multiple applications during a same time interval. Some applications, for instance, may need substantially different performance from the radar. Conflicts can therefore arise with multiple applications attempting to control an operation of the radar.

To address this challenge, techniques are described that provide radar sensing for multiple applications. In an example aspect, a computing device includes middleware, which is coupled between multiple applications and at least one radar system. The multiple applications can utilize radar sensing for a variety of different use cases. Some of the use cases may require different performance from the radar system. To support the multiple applications, the middleware can provide a variety of services, including translation, conflict resolution, resource management, or some combination thereof. With these services, the middleware configures a radar system in a manner that can provide radar sensing to at least a substantial subset of the applications during a given time interval. Furthermore, the middleware can dynamically adjust the operation of the radar system as different applications request radar sensing. The middleware enables the radar system to provide radar sensing for a larger quantity of diverse applications without integrating additional radar systems into the computing device and/or without the applications needing to communicate and/or negotiate with each other. In this way, the middleware can expand the utilization of the radar system, thereby providing additional features to enhance the user experience.

### Operating Environment

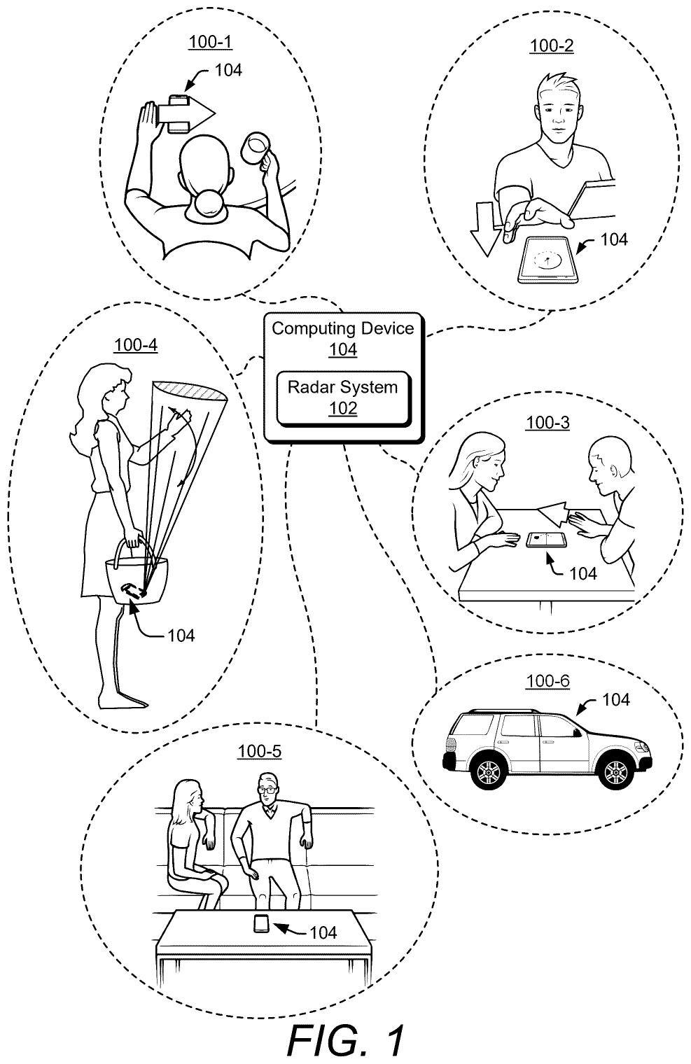

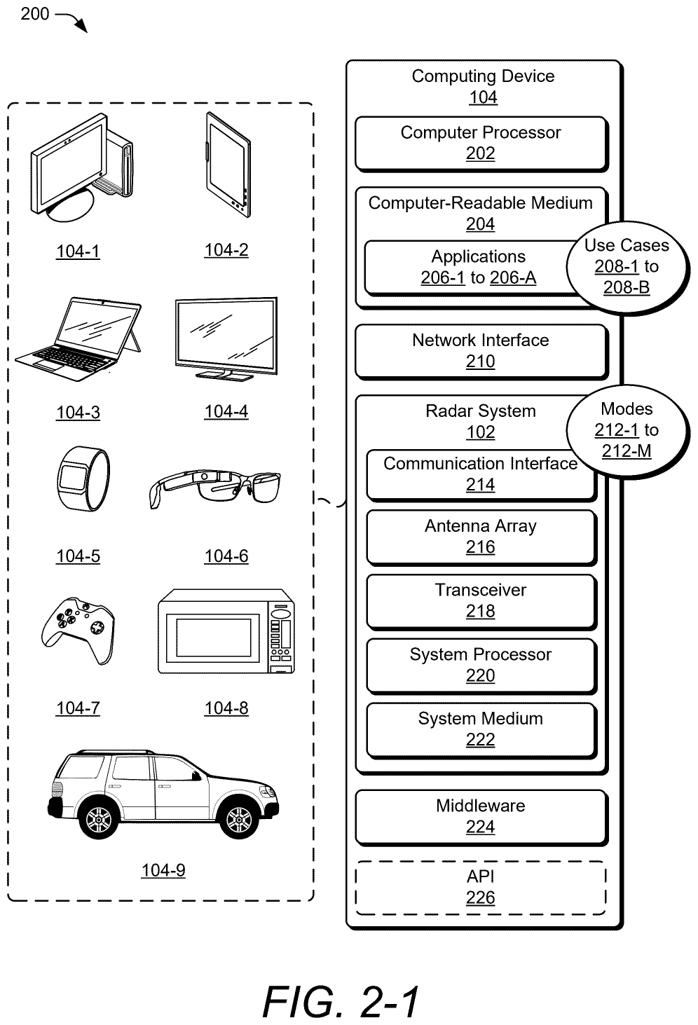

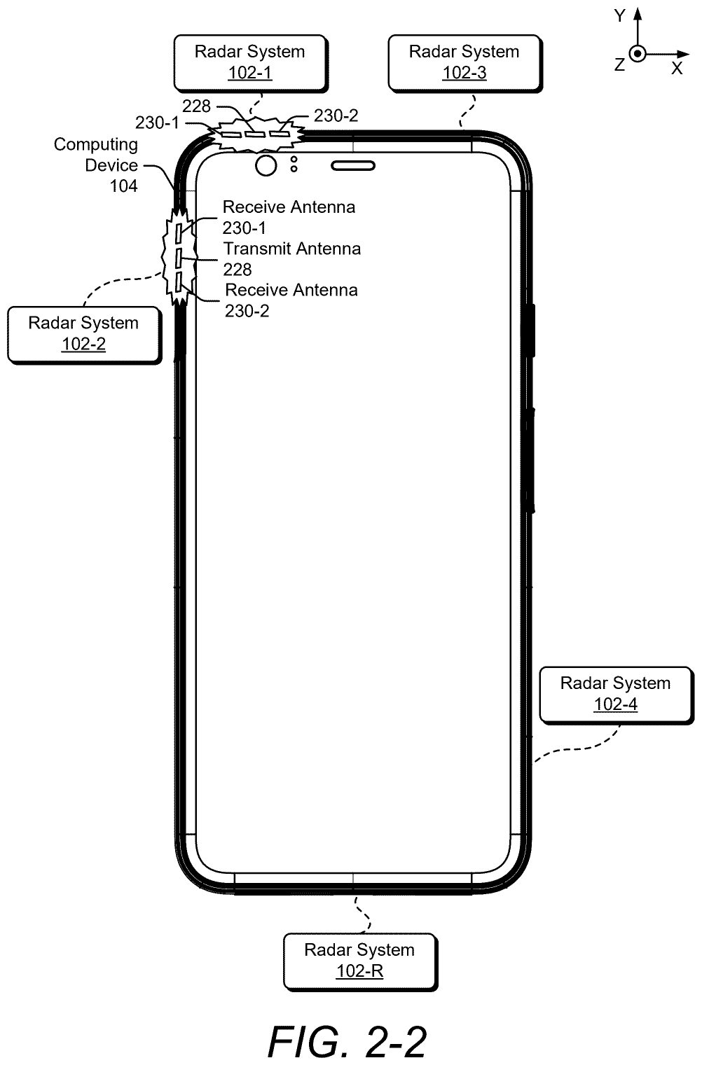

FIG. 1 is an illustration of example environments 100-1 to 100-6 in which techniques using, and an apparatus including, a radar system may be embodied. In the depicted environments 100-1 to 100-6, a computing device 104 includes a radar system 102 capable of interfacing with a variety of different applications of the computing device 104 via middleware (of FIG. 2-1). The computing device 104 is shown to be a smartphone in environments 100-1 to 100-5 and a smart vehicle in the environment 100-6.

In the environments 100-1 to 100-4, various applications of the computing device 104 utilize radar sensing for gesture-based control. In example aspects, a user performs different types of gestures, which are detected by the radar system 102. In some cases, the user performs a gesture using an appendage or body part. Alternatively, the user can also perform a gesture using a stylus, a hand-held object, a ring, or any type of material that can reflect radar signals. Operations of the radar system 102 can be dynamically tailored based on the type of gestures the application supports.

In environment 100-1, the user makes a scrolling gesture by moving a hand above the computing device 104 along a horizontal dimension (e.g., from a left side of the computing device 104 to a right side of the computing device 104). In the environment 100-2, the user makes a reaching gesture, which decreases a distance between the computing device 104 and the user's hand. The users in environment 100-3 make hand gestures to play a game on the computing device 104. In one instance, a user makes a pushing gesture by moving a hand above the computing device 104 along a vertical dimension (e.g., from a bottom side of the computing device 104 to a top side of the computing device 104). In the environment 100-4, the computing device 104 is stored within a purse, and the radar system 102 provides occluded-gesture recognition by detecting gestures that are occluded by the purse.

The radar system 102 can also recognize other types of gestures or motions not shown in FIG. 1. Example types of gestures include a knob-turning gesture in which a user curls their fingers to grip an imaginary doorknob and rotate their fingers and hand in a clockwise or counter-clockwise fashion to mimic an action of turning the imaginary doorknob. Another example type of gesture includes a spindle-twisting gesture, which a user performs by rubbing a thumb and at least one other finger together. The gestures can be two-dimensional, such as those used with touch-sensitive displays (e.g., a two-finger pinch, a two-finger spread, or a tap). The gestures can also be three-dimensional, such as many sign-language gestures, e.g., those of American Sign Language (ASL) and other sign languages worldwide. Upon detecting each of these gestures, the computing device 104 can perform an action, such as display new content, move a cursor, activate one or more sensors, open an application, and so forth. In this way, the radar system 102 provides touch-free control of the computing device 104.

In the environment 100-5, the radar system 102 generates a three-dimensional map of a surrounding environment for contextual awareness. The radar system 102 also detects and tracks multiple users using ambient computing to enable both users to interact with the computing device 104. The radar system 102 can also perform vital-sign detection. In the environment 100-6, the radar system 102 monitors vital signs of a user that drives a vehicle. Example vital signs include a heart rate and a respiration rate. If the radar system 102 determines that the driver is falling asleep, for instance, the radar system 102 can cause the computing device 104 to alert the user. Alternatively, if the radar system 102 detects a life threatening emergency, such as a heart attack, the radar system 102 can cause the computing device 104 to alert a medical professional or emergency services. In some implementations, the radar system 102 in the environment 100-6 can support collision avoidance for autonomous driving and/or navigational assistance. In general, the radar system 102 can support a variety of different applications including touchless gesture controls, presence detection, health monitoring (e.g., sleep tracking or vital sign monitoring), fitness tracking, proximity detection, spatial mapping, collision avoidance, navigational assistance, and human activity recognition (e.g., fall detection, attention, sitting, standing, or sleeping).

Some implementations of the radar system 102 are particularly advantageous as applied in the context of computing devices 104, for which there is a convergence of issues. This can include a need for limitations in a spacing and layout of the radar system 102 and low power. Exemplary overall lateral dimensions of the computing device 104 can be, for example, approximately eight centimeters by approximately fifteen centimeters. Exemplary footprints of the radar system 102 can be even more limited, such as approximately four millimeters by six millimeters with antennas included. Exemplary power consumption of the radar system 102 may be on the order of a few milliwatts to tens of milliwatts (e.g., between approximately two milliwatts and twenty milliwatts). The requirement of such a limited footprint and power consumption for the radar system 102 enables the computing device 104 to include other desirable features in a space-limited package (e.g., a camera sensor, a fingerprint sensor, a display, and so forth).

In general, the example environments 100-1 to 100-6 describe possible use cases in which one or more applications of the computing device 104 can utilize radar sensing. The computing device 104 and the radar system 102 are further described with respect to FIG. 2-1.

FIG. 2-1 illustrates the radar system 102 as part of the computing device 104. The computing device 104 is illustrated with various non-limiting example devices including a desktop computer 104-1, a tablet 104-2, a laptop 104 3, a television 104-4, a computing watch 104-5, computing glasses 104-6, a gaming system 104-7, a microwave 104-8, and a vehicle 104-9. Other devices may also be used, such as a home service device, a smart speaker, a smart thermostat, a security camera, a baby monitor, a Wi-Fi® router, an unmanned aerial vehicle, a trackpad, a drawing pad, a netbook, an e-reader, a home automation and control system, a wall display, and another home appliance. Note that the computing device 104 can be wearable, non-wearable but mobile, or relatively immobile (e.g., desktops and appliances). The radar system 102 can be used as a stand-alone radar system or used with, or embedded within, many different computing devices 104 or peripherals, such as in control panels that control home appliances and systems, in automobiles to control internal functions (e.g., volume, cruise control, or even driving of the car), or as an attachment to a laptop computer to control computing applications on the laptop.

The computing device 104 includes one or more computer processors 202 and at least one computer-readable medium 204, which includes memory media and storage media. An operating system (not shown) embodied as computer-readable instructions on the computer-readable medium 204 can be executed by the computer processor 202 to provide some of the functionalities described herein.

The computer-readable medium 204 also includes multiple applications 206-1 to 206-A, where A represents a positive integer. The applications 206-1 to 206-A can use radar data generated by the radar system 102 for one or more use cases 208-1 to 208-B associated with radar sensing, where B represents a positive integer that may or may not be equal to A. In general, a use case 208 represents a function or service that is provided by the application 206 and utilizes radar data. Example use cases 208 can include presence detection, touchless gesture controls, health monitoring (e.g., sleep tracking or vital sign monitoring), fitness tracking, spatial mapping, collision avoidance, navigational assistance, and human activity recognition (e.g., fall detection, attention, sitting, standing, or sleeping).

In some cases, two or more of the applications 206-1 to 206-A utilize radar sensing for different use cases 208-1 to 208-B. These different use cases 208-1 to 208-B can require different performance or operations from the radar system 102. For example, the application 206-1 can use radar sensing for a first use case 208-1 (e.g., gesture recognition), and the application 206-A can use radar sensing for another use case 208-B (e.g., presence detection or sleep detection). Additionally or alternatively, two or more of the applications 206-1 to 206-A can be associated with a same use case 208. For example, the applications 206-1 and 206-A can both utilize radar sensing for the first use case 208-1 (e.g., gesture recognition). One or more of the applications 206 can utilize radar sensing for multiple use cases 208. The application 206-A, for instance, can utilize radar sensing for both the first use case 208-1 (e.g., gesture recognition) and the other use case 208-B (e.g., presence detection).

The computing device 104 can also include a network interface 210 for communicating data over wired, wireless, or optical networks. For example, the network interface 210 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, and the like. The computing device 104 may also include a display (not shown).

The computing device 104 includes the radar system 102, which can operate in accordance with various modes 212-1 to 212-M, where M represents a positive integer. Each mode 212 can be associated with one or more radar-performance metrics (or radar-performance requirements). A radar-performance metric can include one or more radar performance characteristics, one or more characteristics of an object of interest, and/or one or more characteristics of noise or clutter. These characteristics represent expected mission-level or system-level performance capability of the radar system 102 while operating in accordance with the mode 212. In some cases, the modes 212 are pre-tested and/or pre-approved by the manufacturer of the radar system 102 and/or by a government entity, such as the FCC.

The radar performance characteristic can include information that defines an expected performance of a radar system 102 while operating in a particular mode 212. Example radar performance characteristics can include a level of accuracy with respect to one or more measurements, a resolution capability associated with one or more measurements, a level of responsiveness (e.g., time to acquisition and/or an update rate), and/or a constant false alarm rate (CFAR). A measurement can refer to a position, motion, and/or characteristic of an object. Example position measurements include a slant range, an azimuth angle, and/or an elevation angle. Example motion measurements include a range rate (e.g., a Doppler-derived range rate and/or a range-derived range rate) and/or a velocity. Example object characteristic measurements include a radar-cross-section and/or a material composition.

A mode can also be defined based on the types of objects that can be observed (e.g., detected and/or tracked) while the radar system 102 operates in that mode. Each type of object of interest can be defined by one or more characteristics. Example characteristics of an object of interest can include a set (or range) of positions, a set of velocities, a set of radar cross sections (RCS), and/or a set of material compositions associated with the object of interest. In some cases, the characteristics of the object of interest can be defined by specifying a minimum and/or maximum expected value. For example, the set of positions can include a minimum and/or maximum slant range for detecting the object. As another example, the set of velocities can include a minimum and/or maximum velocity for detecting the object.

Aspects that define characteristics of noise or clutter can include a noise level threshold and/or characteristics of clutter (e.g., expected positions, range rates, radar cross sections, and/or material composition). Some modes 212, for example, can be designed to associate slow-moving objects as clutter. Other modes 212 can be designed to associate close-range objects as clutter.

Each mode 212 can be used to configure the hardware, timing, and/or general operation of one or more radar systems 102 on the computing device 104. For example, a mode 212 associated with a relatively long detection range can specify a transmit power of the radar system 102 such that an object of interest can be detected at a maximum range associated with that mode 212. As another example, a high angular-resolution mode can specify a beamwidth of a main lobe of the radar system 102 that satisfies a target angular resolution associated with that mode 212. Additionally or alternatively, the high angular-resolution mode can specify the quantity of antenna elements that are required along one or more dimensions to provide azimuth and/or elevation measurements. A high-range resolution mode, for instance, can set a pulse width (or bandwidth for pulse compression) of the radar system 102 that satisfies the target range resolution associated with that mode 212. Also, a high-Doppler resolution mode can set a coherent processing interval (CPI) of the radar system 102 that satisfies the target Doppler resolution associated with that mode.

The radar system 102 can implement one or more different types of radar, such as a frequency-modulated continuous-wave (FMCW) radar, a pulse-Doppler radar, a continuous-wave (CW) radar, a phase-modulated spread-spectrum radar, an ultrawideband (UWB) radar, an impulse radar, a radar that uses Zadoff-Chu sequences or constant-amplitude zero-autocorrelation (CAZAC) sequences, or a multiple-input multiple-output (MIMO) radar. In some cases, different modes 212 can be associated with different types of radar.

The radar system 102 includes a communication interface 214 to transmit radar data generated during operation to a remote device, though this need not be used when the radar system 102 is integrated within the computing device 104 along with middleware 224.

The radar system 102 also includes at least one antenna array 216 and at least one transceiver 218 to transmit and receive radar signals. The antenna array 216 includes at least one transmit antenna element and at least one receive antenna element. In some situations, the antenna array 216 includes multiple transmit antenna elements and/or multiple receive antenna elements. With multiple transmit antenna elements and multiple receive antenna elements, the radar system 102 can implement a multiple-input multiple-output radar capable of transmitting multiple distinct waveforms at a given time (e.g., a different waveform per transmit antenna element). The antenna elements can be circularly polarized, horizontally polarized, vertically polarized, or a combination thereof.

Multiple receive antenna elements of the antenna array 216 can be positioned in a one-dimensional shape (e.g., a line) or a two-dimensional shape (e.g., a rectangular arrangement, a triangular arrangement, or an “L” shape arrangement) for implementations that include three or more receive antenna elements. The one-dimensional shape enables the radar system 102 to measure one angular dimension (e.g., an azimuth or an elevation) while the two-dimensional shape enables the radar system 102 to measure two angular dimensions (e.g., to determine both an azimuth angle and an elevation angle of the object). An element spacing associated with the receive antenna elements can be less than, greater than, or equal to half a center wavelength of the radar signal.

The transceiver 218 includes circuitry and logic for transmitting and receiving radar signals via the antenna array 216. Components of the transceiver 218 can include amplifiers, phase shifters, mixers, switches, analog-to-digital converters, or filters for conditioning the radar signals. The transceiver 218 also includes logic to perform in phase/quadrature (I/Q) operations, such as modulation or demodulation. A variety of modulations can be used, including linear frequency modulations, triangular frequency modulations, stepped frequency modulations, or phase modulations. Alternatively, the transceiver 218 can produce radar signals having a relatively constant frequency or a single tone. The transceiver 218 can be configured to support continuous-wave or pulsed radar operations.

A frequency spectrum (e.g., range of frequencies) that the transceiver 218 uses to generate the radar signals can encompass frequencies between 1 and 400 gigahertz (GHz), between 4 and 100 GHz, between 1 and 24 GHz, between 2 and 4 GHz, between 30 and 80 GHz, between 57 and 64 GHz, or at approximately 2.4 GHz. In some cases, the frequency spectrum can be divided into multiple sub-spectrums that have similar or different bandwidths. The bandwidths can be on the order of 500 megahertz (MHz), 1 GHz, 2 GHz, and so forth. In some cases, the bandwidths are approximately 20% or more of a center frequency to implement an ultrawideband radar.

Different frequency sub-spectrums may include, for example, frequencies between approximately 57 and 59 GHz, 59 and 61 GHz, or 61 and 63 GHz. Although the example frequency sub-spectrums described above are contiguous, other frequency sub-spectrums may not be contiguous. To achieve coherence, multiple frequency sub-spectrums (contiguous or not) that have a same bandwidth may be used by the transceiver 218 to generate multiple radar signals, which are transmitted simultaneously or separated in time. In some situations, multiple contiguous frequency sub-spectrums may be used to transmit a single radar signal, thereby enabling the radar signal to have a wide bandwidth.

The radar system 102 also includes one or more system processors 220 and at least one system medium 222 (e.g., one or more computer-readable storage media). The system medium 222 can include instructions that enable low-level signal processing on analog and/or digital samples of a received radar signal to provide real-time signal and/or data processing. Example types of signal processing and/or data processing can include non-coherent integration, clutter rejection, detection thresholding, noise cancellation, Doppler filtering, interferometry, digital beamforming, object tracking, clutter tracking, gesture recognition, presence detection, biometric recognition, navigational aid, and/or health monitoring. These functions can be implemented using heuristic algorithms and/or machine-learned models.

The computing device 104 includes middleware 224 (or radar middleware). The middleware 224 provides an interface between the radar system 102 and multiple entities, such as two or more of the applications 206-1 to 206-A. The middleware 224 can perform a variety of different services, including translation, conflict resolution, and/or resource management. These services enable the middleware 224 to appropriately configure the radar system 102 to operate in accordance with one or more modes 212 that provide radar sensing for multiple applications 206. Through the middleware 224, an application 206 can request information from the radar system 102 without having to understand how the radar system 102 works and without coordinating with other applications 206 that are also utilizing the radar system 102 for radar sensing. The middleware 224 also enables the radar system 102 to provide radar data to the applications 206 without having knowledge of the type of radar data and/or format that is requested by each application 206. Instead, the middleware 224 can appropriately segment, format, and send the requested radar data to each application 206.

The middleware 224 can be implemented as a single entity, or distributed across multiple entities and/or layers. In one example, portions of the middleware 224 are integrated within the radar system 102 and the computing device 104. In another example, the middleware 224 is integrated within the radar system 102 or the computing device 104 (e.g., as part of the computer-readable medium 204).

The computing device 104 can optionally include an application programming interface 226 (e.g., API 226). The application programming interface 226 can also be referred to as a radar application programming interface. The application programming interface 226 provides an interface between the applications 206 and the middleware 224 and/or between the middleware 224 and the radar system 102. In general, the application programming interface 226 provides a standardized language, which the application 206, the middleware 224, and/or the radar system 102 can use to communicate with each other. In some aspects, the application programming interface 226 translates various requests provided by the applications 206 to a potential mode 212 that the radar system 102 can execute. In general, the application programming interface 226 defines the interactions between the applications 206, the middleware 224, and/or the radar system 102, including the types of requests and responses available, how to send a request or response, data formats, and other conventions.

The middleware 224 and the application programming interface 226 can be implemented in software, programmable hardware, or some combination thereof. The middleware 224 and/or the application programming interface 226 can be internal to the radar system 102 or external. In some implementations, the middleware 224 and/or the application programming interface 226 comprise instructions stored within the CRM 204 and executable by the computer processor 202. In other implementations, the instructions for implementing the middleware 224 and/or the application programming interface 226 are stored within a CRM (e.g., system medium 222) of the radar system 102 and executable by a processor (e.g., system processor 220). Some computing devices 104 can include multiple radar systems 102 distributed at different positions within the computing device 104, as further described with respect to FIG. 2-2.

FIG. 2-2 illustrates an example computing device 104 that includes multiple radar systems 102-1, 102-2, 102-3, 102-4 . . . 102-R, where R represents a positive integer. The radar systems 102-1 to 102-R are distributed at different positions around the computing device 104. More specifically, the radar systems 120-1 to 120-R are positioned within or under an exterior housing of the computing device 104. The exterior housing can be substantially transparent to radar signals (e.g., minimally attenuate radar signals). The positions of the radar systems 102-1 to 102-R as shown in FIG. 2-2 can at least represent positions of the antenna arrays 216 and/or front-ends of the transceivers 218. In some implementations, other portions of the radar systems 102-1 to 102-R, such as back-end portions of the transceivers 218, the system processors 220, and/or the system mediums 222, can be positioned elsewhere within the computing device 104. For example, the system processor 220 and/or the system medium 222 can be positioned in a central location that is proximate to the computer processor 202 of the computing device 104.

In some implementations, the radar systems 102-1 to 102-R (or a subset of the radar systems 102-1 to 102-R) can operate in a coordinated manner (e.g., in a same mode 212). This joint operation can enable the radar systems 102-1 to 102-R to improve signal-to-noise ratio performance and/or measure additional angular information about an object. In other implementations, the radar systems 102-1 to 102-R operate independently of each other (e.g., operate in different modes 212). In general, the radar systems 102-1 to 102-R can be individually configured. In some implementations, the radar systems 102-1 to 102-R have distinct components that are not shared. In other implementations, the radar systems 102-1 to 102-R can share some back-end components, such as the system processor 220 and/or the system medium 222.

In some computing devices 104, the radar systems 102-1 to 102-R are positioned around the computing device 104 such that a portion of each radar system 102's antenna pattern overlaps at least one other radar system 102's antenna pattern. In this way, an object can be detected in the overlapping antenna patterns of at least two of the radar systems 102 at various locations around the computing device 104.

Different positions within or around the computing device 104 can be better for particular use cases 208. For example, some positions can be better for detecting certain types of gestures performed by a user. In particular, these positions can increase a radar system 102's probability of detecting the user by increasing the radar system 102's signal-to-noise ratio. Also, some positions can increase the overlap between a radar system 102's antenna pattern and a region of interest in which the user is likely to perform gestures or interact with the computing device 104. The positions of the radar systems 102-4 and 102-R, for instance, can be better for detecting gestures as these radar systems 102-4 and 102-R are closer to the body of the user as the user holds the computing device 104 in the depicted portrait orientation. Alternatively, the radar systems 102-1 and/or 120-2 can be better positioned for detecting gestures if the user holds the computing device 104 in a landscape orientation (not shown).

In some implementations, the radar systems 102-1 to 102-R have multiple antennas that form an antenna array 216, such as multiple transmit antennas 228 and/or multiple receive antennas 230. Consider an example in which the radar systems 102-1 to 102-R each include at least two receive antennas 230-1 and 230-2, which form a linear antenna array. Orientations of these linear antenna arrays can be based on the position of the corresponding radar system 102. For example, the receive antennas 230-1 and 230-2 of the radar system 102-1 can be aligned along the X axis to enable the radar system 102-1 to measure azimuth angles of objects. As another example, the receive antennas 230-1 and 230-2 of the radar system 102-2 can be aligned along the Y axis to enable the radar system 102-2 to measure elevation angles of objects.

The radar systems 102-1 to 102-R can represent a same type of radar system or different types of radar systems. The radar systems 102-1 to 102-R may be configured to operate in a similar or different manner. For example, the radar systems 102-1 to 102-R can utilize similar or different frequencies, duty cycles, interpulse periods, radar framing structures 314, modulation schemes, monostatic or bistatic operations, and so forth. For example, one radar system 102 can operate as an ultra-wideband radar, which may have optimal performance for a first type of use case 208 (e.g., sleep sensing), and a second radar system 102 can operate as a frequency-modulated continuous-wave radar system, which may have optimal performance for a second type of use case 208 (e.g., presence detection and/or gesture recognition). This variety can provide additional advantages for providing radar sensing for multiple applications 206, especially in terms of flexibility. The middleware 224, for instances, can configure a first set of the radar systems 102 to support a first set of the multiple applications 206 and configure a second set of the radar systems 102 to support a second set of the multiple applications 206.

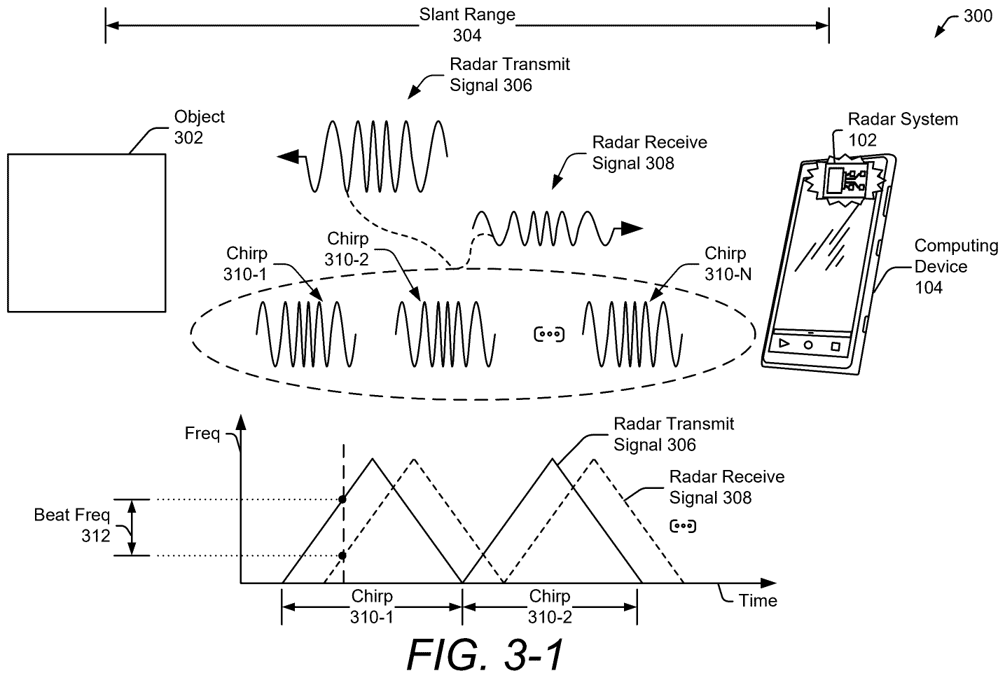

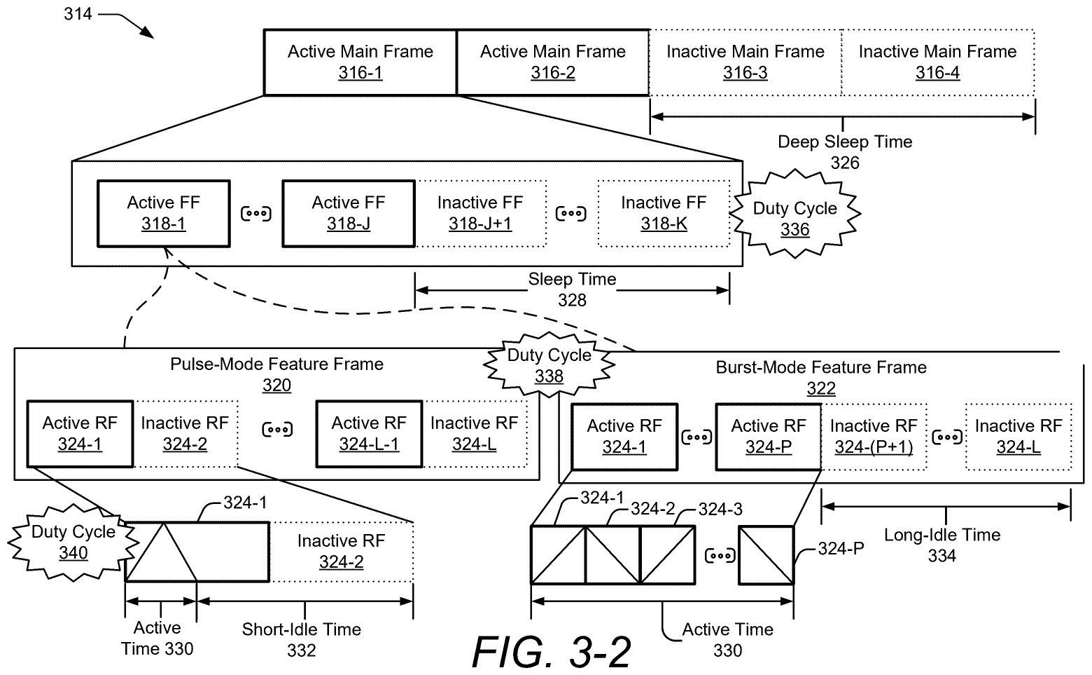

Although the computing device 104 of FIG. 2-2 is shown to include five radar systems 102, other implementations of the computing device 104 can have any quantity of radar systems 102 that is greater than or equal to one. For example, the computing device 104 can include one radar system 102, such as radar system 102-1. As another example, the computing device 104 can include two radar systems 102, such as radar systems 102-1 and 102-2. In some cases, the two radar systems 102 are oriented along different axes to enable two-dimensional angular information to be determined. An operation of any of the radar systems 102-1 to 102-R is further described with respect to FIG. 3-1.

FIG. 3-1 illustrates an example operation of the radar system 102. In the depicted configuration, the radar system 102 is implemented as a frequency-modulated continuous-wave radar. However, other types of radar architectures can be implemented, as described above with respect to FIGS. 2-1 and 2-2. In environment 300, an object 302 is located at a particular slant range 304 from the radar system 102. The object 302 generally represents an object of interest for a radar-sensing use case 208. For gesture recognition, for instance, the object 302 can be an appendage of the user (e.g., a hand, a finger, or an arm), an item that is worn by the user, or an item that is held by the user (e.g., a stylus). For collision avoidance, the object 302 can be another vehicle.

To detect the object 302, the radar system 102 transmits a radar transmit signal 306. In some cases, the radar system 102 can transmit the radar transmit signal 306 using a substantially broad radiation pattern. For example, a main lobe of the radiation pattern can have a beamwidth that is approximately 90 degrees or greater (e.g., approximately 110, 130, or 150 degrees). This broad radiation pattern provides the user more flexibility in where they perform a gesture. In an example implementation, a center frequency of the radar transmit signal 306 can be approximately 60 GHz, and a bandwidth of the radar transmit signal 306 can be between approximately 4 and 6 GHz (e.g., approximately 4.5 or 5.5 GHz). The term “approximately” can mean that the bandwidths can be within +/−10% of a specified value or less (e.g., within +/−5%, +/−3%, or +/−2% of a specified value).

At least a portion of the radar transmit signal 306 is reflected by the object 302. This reflected portion represents a radar receive signal 308. The radar system 102 receives the radar receive signal 308 and processes the radar receive signal 308 to extract data for one or more applications 206. As depicted, an amplitude of the radar receive signal 308 is smaller than an amplitude of the radar transmit signal 306 due to losses incurred during propagation and reflection.

The radar transmit signal 306 includes a sequence of chirps 310-1 to 310-N, where N represents a positive integer greater than one. The radar system 102 can transmit the chirps 310-1 to 310-N in a continuous burst or transmit the chirps 310-1 to 310-N as time-separated pulses, as further described with respect to FIG. 3-2. A duration of each chirp 310-1 to 310-N can be on the order of tens or thousands of microseconds (e.g., between approximately 30 microseconds (μs) and 5 milliseconds (ms)). An example pulse repetition frequency (PRF) of the radar system 102 can be greater than 1500 Hz, such as approximately 2000 Hz or 3000 Hz. The term “approximately” can mean that the pulse repetition frequencies of can be within +/−10% of a specified value or less (e.g., within +/−5%, +/−3%, or +/−2% of a specified value).

Individual frequencies of the chirps 310-1 to 310-N can increase or decrease over time. In the depicted example, the radar system 102 employs a two-slope cycle (e.g., triangular frequency modulation) to linearly increase and linearly decrease the frequencies of the chirps 310-1 to 310-N over time. The two-slope cycle enables the radar system 102 to measure the Doppler frequency shift caused by motion of the object 302. In general, transmission characteristics of the chirps 310-1 to 310-N (e.g., bandwidth, center frequency, duration, and transmit power) can be tailored to achieve a particular detection range, range resolution, or Doppler sensitivity for detecting one or more characteristics the object 302. The term “chirp” generally refers to a segment or portion of the radar signal. For pulse-Doppler radar, the “chirp” represents individual pulses of a pulsed radar signal. For continuous-wave radar, the “chirp” represents segments of a continuous-wave radar signal.

At the radar system 102, the radar receive signal 308 represents a delayed version of the radar transmit signal 306. The amount of delay is proportional to the slant range 304 (e.g., distance) from the antenna array 216 of the radar system 102 to the object 302. In particular, this delay represents a summation of a time it takes for the radar transmit signal 306 to propagate from the radar system 102 to the object 302 and a time it takes for the radar receive signal 308 to propagate from the object 302 to the radar system 102. If the object 302 is moving, the radar receive signal 308 is shifted in frequency relative to the radar transmit signal 306 due to the Doppler effect. A difference in frequency between the radar transmit signal 306 and the radar receive signal 308 can be referred to as a beat frequency 312. A value of the beat frequency is based on the slant range 304 and the Doppler frequency. Similar to the radar transmit signal 306, the radar receive signal 308 is composed of one or more of the chirps 310-1 to 310-N. The multiple chirps 310-1 to 310-N enable the radar system 102 to make multiple observations of the object 302 over a predetermined time period. A radar framing structure determines a timing of the chirps 310-1 to 310-N, as further described with respect to FIG. 3-2.

FIG. 3-2 illustrates an example radar framing structure 314. In the depicted configuration, the radar framing structure 314 includes three different types of frames. At a top level, the radar framing structure 314 includes a sequence of main frames 316 (or main frames), which can be in an active state or an inactive state. Generally speaking, the active state consumes a larger amount of power relative to the inactive state. At an intermediate level, the radar framing structure 314 includes a sequence of feature frames 318, which can similarly be in the active state or the inactive state. Different types of feature frames 318 include a pulse-mode feature frame 320 (shown at the bottom-left of FIG. 3-2) and a burst-mode feature frame 322 (shown at the bottom-right of FIG. 3-2). At a low level, the radar framing structure 314 includes a sequence of radar frames (RF) 324, which can also be in the active state or the inactive state.

The radar system 102 transmits and receives a radar signal during an active radar frame 324. In some situations, the radar frames 324 are individually analyzed for basic radar operations, such as search and track, clutter map generation, user location determination, and so forth. Radar data collected during each active radar frame 324 can be saved to a buffer after completion of the radar frame 324 or provided directly to the system processor 220 of FIG. 2-1.

The radar system 102 analyzes the radar data across multiple radar frames 324 (e.g., across a group of radar frames 324 associated with an active feature frame 318) to identify a particular feature. Example types of features include one or more stationary objects within the external environment, material characteristics of these one or more objects (e.g., reflective properties), physical characteristics (e.g., size) of these one or more objects. To perform gesture recognition during an active main frame 316, for instance, the radar system 102 analyzes the radar data associated with multiple active feature frames 318. In general, the radar system 102 can collect data associated with any type of use case during an active main frame 316.

A duration of the main frame 316 may be on the order of milliseconds or seconds (e.g., between approximately 10 milliseconds and 10 seconds). After active main frames 316-1 and 316-2 occur, the radar system 102 is inactive, as shown by inactive main frames 316-3 and 316-4. A duration of the inactive main frames 316-3 and 316-4 is characterized by a deep sleep time 326, which may be on the order of tens of milliseconds or more (e.g., greater than 50 milliseconds). In an example implementation, the radar system 102 turns off all of the active components (e.g., an amplifier, an active filter, a voltage-controlled oscillator (VCO), a voltage-controlled buffer, a multiplexer, an analog-to-digital converter, a phase-lock loop (PLL) or a crystal oscillator) within the transceiver 218 to conserve power during the deep sleep time 326.

The deep sleep time 326 can be appropriately set to enable sufficient reaction and responsiveness while conserving power. In other words, the deep sleep time 326 can be sufficiently short to enable the radar system 102 to satisfy the “always on” aspect while also enabling power to be conserved whenever possible. In some cases, the deep sleep time 326 can be dynamically adjusted based on an amount of activity detected by the radar system 102 or based on whether the radar system 102 determines that the user is present. If the activity level is relatively high or the user is close enough to the radar system 102, the radar system 102 can reduce the deep sleep time 326 to increase responsiveness. Alternatively, if the activity level is relatively low or the user is sufficiently far from the radar system 102 so as not to be able to engage in certain activities for a radar-sensing use case 208 (e.g., gestures) within a designated distance interval, the radar system 102 can increase the deep sleep time 326.

In the depicted radar framing structure 314, each main frame 316 includes K feature frames 318, where K is a positive integer. If the main frame 316 is in the inactive state, all of the feature frames 318 associated with that main frame 316 are also in the inactive state. In contrast, an active main frame 316 includes J active feature frames 318 and K-J inactive feature frames 318, where J is a positive integer that is less than or equal to K. A quantity of feature frames 318 can be adjusted based on a complexity of the environment or a complexity of a radar-sensing use case. For example, a main frame 316 can include a few to a hundred feature frames 318 or more (e.g., K may equal 2, 10, 30, 60, or 100). A duration of each feature frame 318 may be on the order of milliseconds (e.g., between approximately 1 ms and 50 ms). In example implementations, the duration of each feature frame 318 is between approximately 30 and 50 ms.

To conserve power, the active feature frames 318-1 to 318-J occur prior to the inactive feature frames 318-(J+1) to 318-K. A duration of the inactive feature frames 318-(J+1) to 318-K is characterized by a sleep time 328. In this way, the inactive feature frames 318-(J+1) to 318-K are consecutively executed such that the radar system 102 can be in a powered-down state for a longer duration relative to other techniques that may interleave the inactive feature frames 318-(J+1) to 318-K with the active feature frames 318-1 to 318-J. Generally speaking, increasing a duration of the sleep time 328 enables the radar system 102 to turn off components within the transceiver 218 that require longer start-up times.

Each feature frame 318 includes L radar frames 324, where L is a positive integer that may or may not be equal to J or K. In some implementations, a quantity of radar frames 324 may vary across different feature frames 318 and may comprise a few frames or hundreds of frames (e.g., L may be equal to 5, 15, 30, 100, or 500). A duration of a radar frame 324 may be on the order of tens or thousands of microseconds (e.g., between approximately 30 μs and 5 ms). The radar frames 324 within a particular feature frame 318 can be customized for a predetermined detection range, range resolution, or doppler sensitivity, which facilitates detection of a particular feature. For example, the radar frames 324 may utilize a particular type of modulation, bandwidth, frequency, transmit power, or timing. If the feature frame 318 is in the inactive state, all of the radar frames 324 associated with that feature frame 318 are also in the inactive state.

The pulse-mode feature frame 320 and the burst-mode feature frame 322 include different sequences of radar frames 324. Generally speaking, the radar frames 324 within an active pulse-mode feature frame 320 transmit pulses that are separated in time by a predetermined amount. This disperses observations over time, which can make it easier for the radar system 102 to provide radar sensing for some types of use cases 208, such as gesture recognition, due to larger changes in the observed chirps 310-1 to 310-N within the pulse-mode feature frame 320 relative to the burst-mode feature frame 322. In contrast, the radar frames 324 within an active burst-mode feature frame 322 transmit pulses continuously across a portion of the burst-mode feature frame 322 (e.g., the pulses are not separated by a predetermined amount of time). This enables an active-burst-mode feature frame 322 to consume less power than the pulse-mode feature frame 320 by turning off a larger quantity of components, including those with longer start-up times, as further described below. This may be applicable for other types of use cases 208, such as presence detection or ambient computing, which may be active for a longer period of time.

Within each active pulse-mode feature frame 320, the sequence of radar frames 324 alternates between the active state and the inactive state. Each active radar frame 324 transmits a chirp 310 (e.g., a pulse), which is illustrated by a triangle. A duration of the chirp 310 is characterized by an active time 330. During the active time 330, components within the transceiver 218 are powered-on. During a short-idle time 332, which includes the remaining time within the active radar frame 324 and a duration of the following inactive radar frame 324, the radar system 102 conserves power by turning off one or more active components within the transceiver 218 that have a start-up time within a duration of the short-idle time 332.

An active burst-mode feature frame 322 includes P active radar frames 324 and L-P inactive radar frames 324, where P is a positive integer that is less than or equal to L. To conserve power, the active radar frames 324-1 to 324-P occur prior to the inactive radar frames 324-(P+1) to 324-L. A duration of the inactive radar frames 324-(P+1) to 324-L is characterized by a long-idle time 334. By grouping the inactive radar frames 324-(P+1) to 324-L together, the radar system 102 can be in a powered-down state for a longer duration relative to the short-idle time 332 that occurs during the pulse-mode feature frame 320. Additionally, the radar system 102 can turn off additional components within the transceiver 218 that have start-up times that are longer than the short-idle time 332 and shorter than the long-idle time 334.

Each active radar frame 324 within an active burst-mode feature frame 322 transmits a portion of the chirp 310. In this example, the active radar frames 324-1 to 324-P alternate between transmitting a portion of the chirp 310 that increases in frequency and a portion of the chirp 310 that decreases in frequency.

The radar framing structure 314 enables power to be conserved through adjustable duty cycles within each frame type. A first duty cycle 336 is based on a quantity of active feature frames 318 (J) relative to a total quantity of feature frames 318 (K). A second duty cycle 338 is based on a quantity of active radar frames 324 (e.g., L/2 or P) relative to a total quantity of radar frames 324 (L). A third duty cycle 340 is based on a duration of the chirp 310 relative to a duration of a radar frame 324.

Consider an example radar framing structure 314 for a power state that consumes approximately 2 milliwatts (mW) of power and has a main-frame update rate between approximately 1 and 4 hertz (Hz). In this example, the radar framing structure 314 includes a main frame 316 with a duration between approximately 250 ms and 1 second. The main frame 316 includes thirty-one pulse-mode feature frames 320 (e.g., K is equal to 31). One of the thirty-one pulse-mode feature frames 320 is in the active state. This results in the duty cycle 336 being approximately equal to 3.2%. A duration of each pulse-mode feature frame 320 is between approximately 8 and 32 ms. Each pulse-mode feature frame 320 is composed of eight radar frames 324 (e.g., L is equal to 8). Within the active pulse-mode feature frame 320, all eight radar frames 324 are in the active state. This results in the duty cycle 338 being equal to 100%. A duration of each radar frame 324 is between approximately 1 and 4 ms. An active time 330 within each of the active radar frames 324 is between approximately 32 and 128 μs. As such, the resulting duty cycle 340 is approximately 3.2%. This example radar framing structure 314 has been found to yield good performance results while also yielding good power efficiency results in the application context of a handheld smartphone in a low-power state. Furthermore, this performance enables the radar system 102 to satisfy power consumption and size constraints while maintaining responsiveness. The power savings can enable the radar system 102 to continuously transmit and receive radar signals over a time period of at least an hour in power-constrained devices. In some cases, the radar system 102 can operate over a period of time on the order of tens of hours or multiple days.

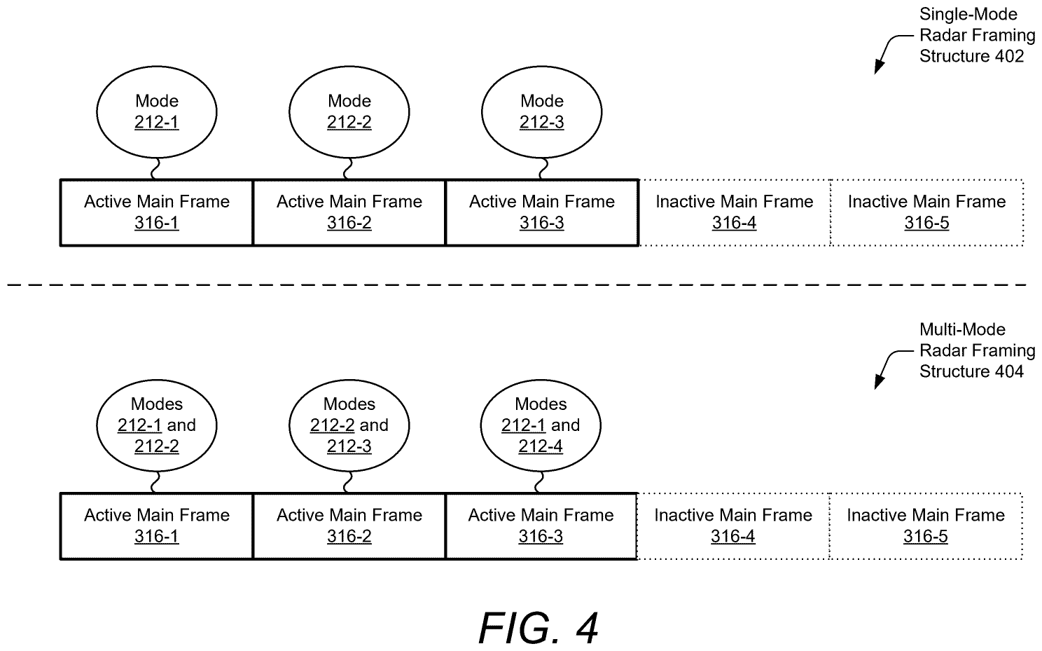

Although two-slope cycle signals (e.g., triangular frequency modulated signals) are explicitly shown in FIGS. 3-1 and 3-2, these techniques can be applied to other types of signals, including those mentioned with respect to FIG. 2-1. Each active main frame 316 can be associated with one or more modes 212, as further described with respect to FIG. 4.

FIG. 4 illustrates two different types of radar framing structures 314 that enable the radar system 102 to operate in accordance with multiple modes 212. At the top of FIG. 4, an example single-mode radar framing structure 402 enables the radar system 102 to provide radar sensing for multiple applications 206. Each active main frame 316 of the single-mode radar framing structure 402 is associated with a single mode 212. In the depicted example, the active main frames 316-1, 316-2, and 316-3 are respectively associated with modes 212-1, 212-2, and 212-3. Each of the modes 212-1 to 212-3 can be used to support different use cases 208 associated with at least two different applications 206.

The single-mode radar framing structure 402 enables the radar system 102 to operate in accordance with multiple modes 212 in a sequential manner. While this may simplify the overall operation and processing for the radar system 102, it may be inefficient from a timing resource perspective. Due to the sequential nature of the single-mode radar framing structure 402, the radar system 102 can be limited in how often it can operate in a particular mode 212 or how many modes 212 it can support during a particular time interval. Alternatively, the radar system 102 can utilize a multi-mode radar framing structure 404, which is shown at the bottom of FIG. 4.

The multi-mode radar framing structure 404 also enables the radar system 102 to provide radar sensing for multiple applications 206. In contrast to the active main frames 316 of the single-mode radar framing structure 402, the active main frames 316 of the multi-mode radar framing structure 404 are associated with at least two modes 212. This means that the active radar frames 324 associated with the multiple modes 212 are interleaved in some manner to form the active main frame 316, examples of which are further described with respect to FIGS. 5-1 to 5-3.

In the example multi-mode radar framing structure 404 shown in FIG. 4, the active main frames 316-1, 316-2, and 316-3 are each associated with two modes 212. The first active main frame 316-1 is associated with the modes 212-1 and 212-2. The second active main frame 316-2 is associated with the modes 212-2 and 212-3. The third active main frame 316-3 is associated with the modes 212-1 and 212-4. Other implementations are also possible in which one or more of the active main frames 316 are associated with three or more modes 212.

Within the single-mode radar framing structure 402 and the multi-mode radar framing structure 404, the active main frames 316-1 to 316-3 occur prior to the inactive main frames 316-4 and 316-5. The inactive main frames 316-4 and 316-5 can allow the radar system 102 to conserve power and/or meet other regulations and guidelines, including those provided by agencies such as the FCC.

In some implementations of the single-mode radar framing structure 402 or the multi-mode radar framing structure 404, a mode 212 can span multiple sequential active main frames 316 prior to one or more inactive main frames 316. The second mode 212-2 within the multi-mode radar framing structure 404, for instance, is associated with the active main frames 316-1 and 316-2. This can be advantageous for situations in which the mode 212-2 has a larger quantity of active radar frames 324 compared to the modes 212-1 and 212-3.

In other implementations of the single-mode radar framing structure 402 or the multi-mode radar framing structure 404, a mode 212 can be associated with multiple main frames 316 in a non-sequential manner prior to one or more inactive main frames 316. The first mode 212-1, for instance, is associated with the active main frames 316-1 and 316-3. This can be advantageous for situations in which the mode 212-1 is associated with a higher level of responsiveness that requires more observations in a shorter time period compared to other modes.

The multi-mode radar framing structure 404 can provide a more efficient way of utilizing timing resources and servicing multiple modes 212 compared to the single-mode radar framing structure 402. In one aspect, the multi-mode radar framing structure 404 can enable the radar system 102 to operate in accordance with a larger quantity of modes 212 in a given time period compared to the single-mode radar framing structure 402. In the example shown in FIG. 4, the single-mode radar framing structure 402 can operate in accordance with three modes 212-1 to 212-3 during a time period associated with three active main frames 316-1 to 316-3 while the multi-mode radar framing structure 404 can operate in accordance with four modes 212-1 to 212-4 during the same time period.

Another benefit associated with the multi-mode radar framing structure 404 is an option for reducing a time period between operations associated with a particular mode 212. For example, the radar system 102 can operate in accordance with the first mode 212-1 during the active main frames 316-1 and 316-3. In contrast, the single-mode radar framing structure 402 may not be able to operate in accordance with the first mode 212 until another active main frame 316 that occurs after the active main frame 316-3.

The main frames 316-1 to 316-5 associated with the single-mode radar framing structure 402 and/or the multi-mode radar framing structure 404 can have similar or different durations. In an example implementation, two or more of the active main frames 316-1 to 316-3 can have a same duration. In another example implementation, two or more of the active main frames 316-1 to 316-3 can have different durations. Durations of the active main frames 316 can also differ from the durations of the inactive main frames 316. In general, a duration of an active main frame 316 is sufficient to enable the radar system 102 to operate in accordance with one or more modes 212. A duration of the inactive main frames 316 is sufficient to let the radar system 102 satisfy power requirements and/or meet other regulations or guidelines.

The multi-mode radar framing structure 404 enables multiple modes 212 to occur during an active main frame 316 using time-sharing techniques. More specifically, the active radar frames 324 associated with the different modes 212 are interleaved during the active main frame 316. Example interleaving techniques are further described with respect to FIGS. 5-1, 5-2, and 5-3.

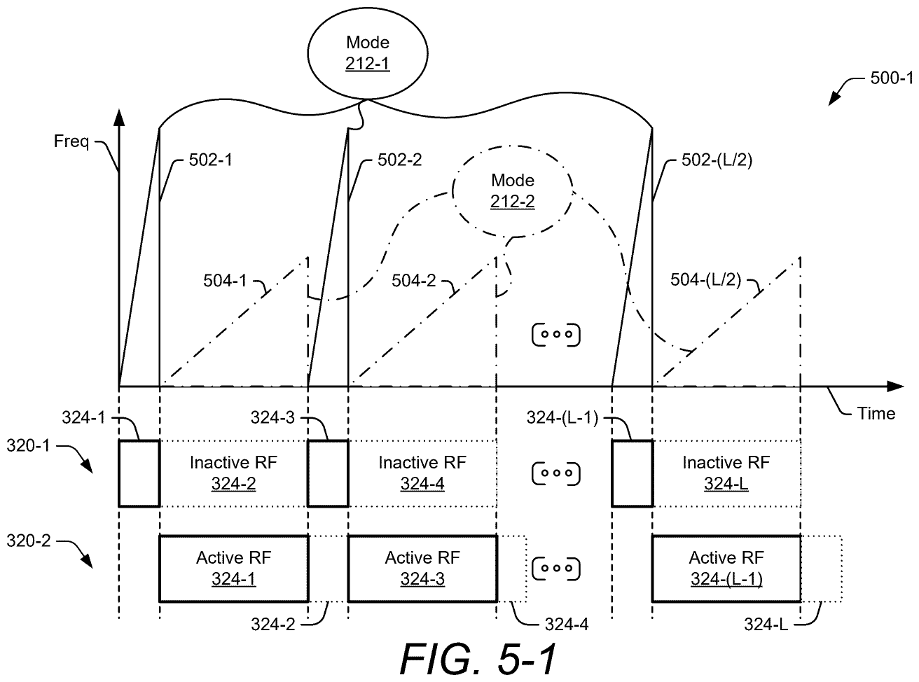

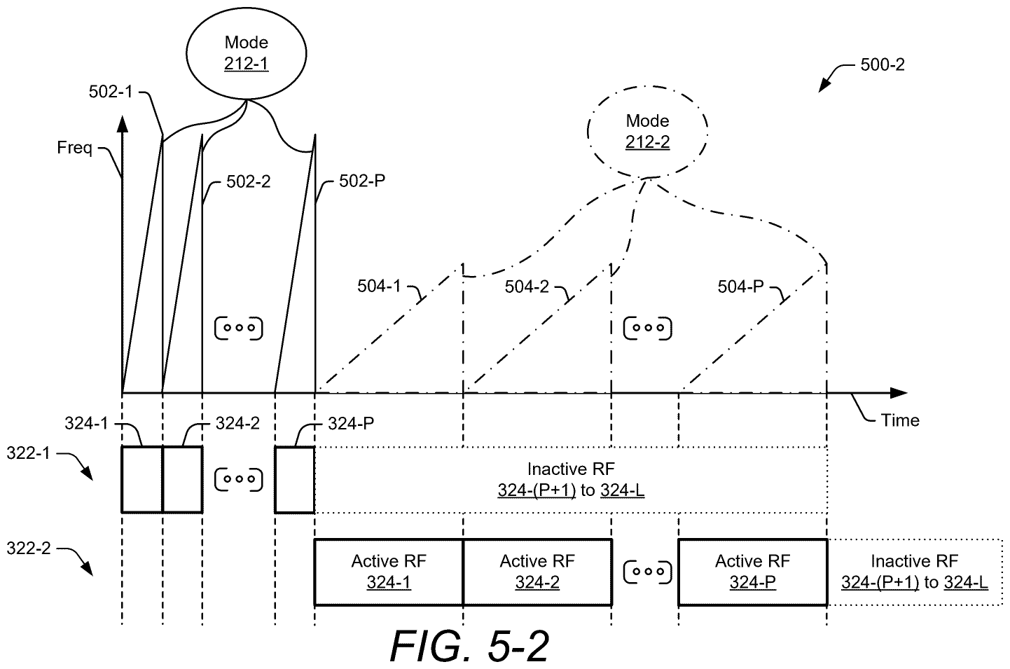

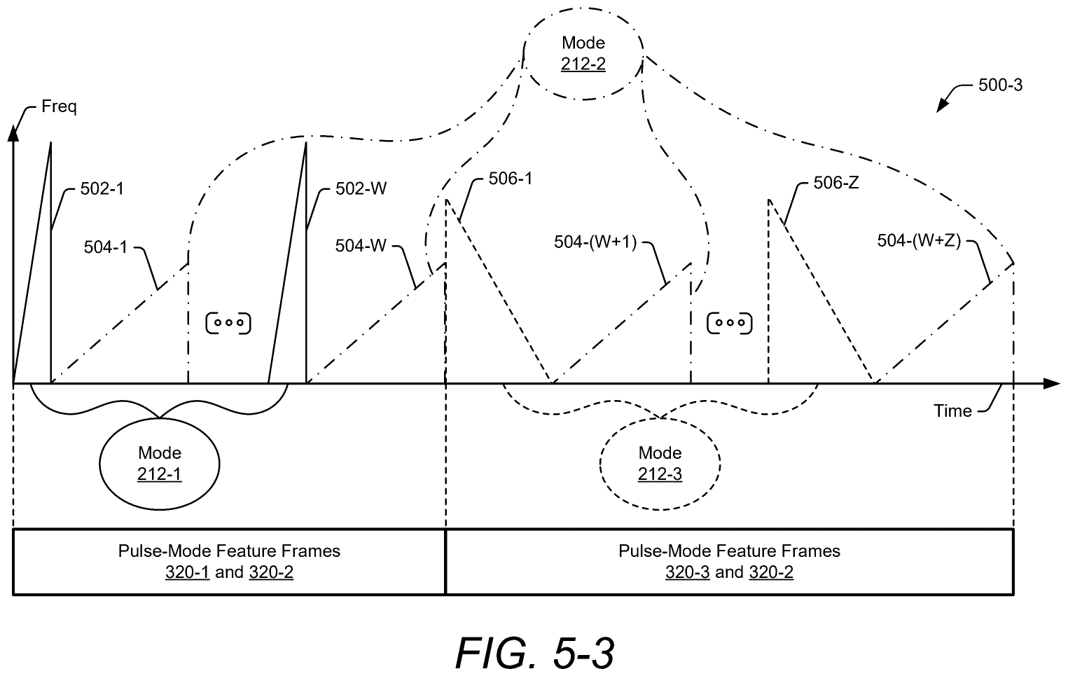

FIG. 5-1 illustrates a first example in which the radar system 102 operates in accordance with two modes 212-1 and 212-2 for providing radar sensing for multiple applications 206. In this example, the first mode 212-1 can have a radar performance characteristic associated with a high velocity (or range-rate) resolution and a short detection range compared to the second mode 212-2. In contrast, the second mode 212-2 can have a radar performance characteristic associated with a medium detection range. The first mode 212-1 can support gesture recognition while the second mode 212-2 can support presence detection, for instance.

The modes 212-1 and 212-2 can be associated with the active main frame 316-1 of FIG. 4. In this example, the active main frame 316-1 includes multiple radar frames 324 that are scheduled in a manner associated with the pulse-mode feature frame 320. For example, the first mode 212-1 is associated with a first pulse-mode feature frame 320-1, and the second mode 212-2 is associated with a second pulse-mode feature frame 320-2. The active radar frames 324 of the pulse-mode feature frames 320-1 and 320-2 are depicted with solid lines, and the inactive radar frames 324 of the pulse-mode feature frames 320-1 and 320-2 are depicted with dotted lines. In this example, the pulse-mode feature frames 320-1 and 320-2 are similar in that they include a same quantity of radar frames 324. The pulse-mode feature frames 320-1 and 320-2 are also similar in that each include active radar frames 324-1, 324-3, and 324-(L−1) and inactive radar frames 324-2, 324-4, and 324-L. Other implementations are also possible in which the pulse-mode feature frames 320-1 and 320-2 have a different quantity of radar frames 324 and/or a different quantity of active and/or inactive radar frames 324. Durations of the active radar frames 324 and the inactive radar frames 324 can differ between the pulse-mode feature frames 320-1 and 320-2.

To interleave the modes 212-1 and 212-2, the burst-mode feature frames 322-1 and 322-2 are interleaved to form the active main frame 316-1. More specifically, the second pulse-mode feature frame 320-2 has active radar frames 324 that occur during a time period in which the first pulse-mode feature frame 320-1 has inactive radar frames 324. For example, the active radar frame 324-1 of the second pulse-mode feature frame 320-2 occurs during a same time period as the inactive radar frame 324-2 of the first pulse-mode feature frame 320-1. Likewise, the first pulse-mode feature frame 320-1 has active radar frames 324 that occur during a time period in which the second pulse-mode feature frame 320-2 has inactive radar frames 324. For example, the active radar frame 324-3 of the first pulse-mode feature frame 320-1 occurs during a same time period as the inactive radar frame 324-2 of the second pulse-mode feature frame 320-2.

Graph 500-1 of FIG. 5-1 depicts chirps 502-1, 502-2 . . . 502-(L/2) associated with the active radar frames 324 of the first pulse-mode feature frame 320-1 and chirps 504-1, 504-2 . . . 504-(L/2) associated with the active radar frames 324 of the second pulse-mode feature frame 320-2. The chirps 502-1 to 502-(L/2) and the chirps 504-1 to 504-(L/2) are separated in time such that there is a short-idle time 332 between sequential chirps associated with the same mode 212.

The interleaving scheme shown in FIG. 5-1 based on the pulse-mode feature frame 320 can be advantageous in allowing the radar system 102 to make multiple observations for each mode 212 over an extended time frame. In some situations, however, it is desirable to interleave multiple modes 212 based on the burst-mode feature frame 322, as further described with respect to FIG. 5-2.

FIG. 5-2 illustrates a second example interleaving of the first and seconds modes 212-1 and 212-2. In this example, the modes 212-1 and 212-2 of FIG. 5-2 are similar to the modes 212-1 and 212-2 of FIG. 5-1 and have similar chirps 502 and 504. A timing and/or interleaving of the chirps 502 and 504 differs between FIGS. 5-1 and 5-2, as further described below.

In FIG. 5-2, the modes 212-1 and 212-2 are associated with the active main frame 316-1 of FIG. 4. In this example, the active main frame 316-1 includes multiple radar frames 324 that are scheduled in a manner associated with the burst-mode feature frame 322. For example, the first mode 212-1 is associated with a first burst-mode feature frame 322-1, and the second mode 212-2 is associated with a second burst-mode feature frame 322-2. The active radar frames 324 of the burst-mode feature frames 322-1 and 322-2 are depicted with solid lines, and the inactive radar frames 324 of the burst-mode feature frames 322-1 and 322-2 are depicted with dotted lines. In this example, the burst-mode feature frames 322-1 and 322-2 are similar in that they include the same quantity of radar frames 324. The burst-mode feature frames 322-1 and 322-2 are also similar in that each includes active radar frames 324-1, 324-2 . . . 324-P and inactive radar frames 324-(P+1) to 324-L. Other implementations are also possible in which the burst-mode feature frames 322-1 and 322-2 have a different quantity of radar frames 324 and/or a different quantity of active and/or inactive radar frames 324. Durations of the active radar frames 324 and/or the inactive radar frames 324 can differ between the burst-mode feature frames 322-1 and 322-2.

To interleave the modes 212-1 and 212-2, the burst-mode feature frames 322-1 and 322-2 are interleaved to form the active main frame 316-1. More specifically, the second burst-mode feature frame 322-2 has active radar frames 324 that occur during a time period in which the first burst-mode feature frame 322-1 has inactive radar frames 324. For example, the active radar frames 324-1, 324-2 . . . 324-P of the second burst-mode feature frame 322-2 occur during a same time period as the inactive radar frames 324-(P+1) to 324-L of the first burst-mode feature frame 322-1. The inactive radar frames 324-(P+1) to 324-L of the second burst-mode feature frame 322-2 can also occur during the inactive radar frames 324 of the first burst-mode feature frame 322-1 or can occur during the active radar frames 324 of subsequent burst-mode feature frame 322 associated with a subsequent active main frame 316.

Graph 500-2 depicts the chirps 502-1, 502-2 . . . 502-P associated with the first mode 402-1 and the chirps 504-1, 504-2 . . . 504-P associated with the second mode 402-2. The chirps 502-1 to 502-P associated with the first mode 402-1 are transmitted prior to the chirps 504-1 to 504-P associated with the second mode 402-2. Other radar framing structures 314 are also possible in which the radar system 102 supports more than two modes during a given time interval, as further described with respect to FIG. 5-3.

FIG. 5-3 illustrates a third example in which the radar system 102 operates in accordance with three modes 212-1, 212-2, and 212-3 for providing radar sensing for multiple applications 206. As depicted in a graph 500-3, the radar system 102 interleaves chirps 502-1 to 502-W associated with the pulse-mode feature frame 320-1 of the first mode 212-1 with a first set of chirps 504-1 to 504-W associated with the pulse-mode feature frame 320-2 of the second mode 212-2 during a first time interval. During a second time interval, the radar system 102 interleaves chirps 506-1 to 506-Z associated with a third pulse-mode feature frame 320-3 of the third mode 212-3 and a second set of chirps 504-(W+1) to 504-(W+Z) associated with the second pulse-mode feature frame 320-2 of the second mode 212-2. In some implementations, the first time interval can be associated with a first active main frame 316-1 of the multi-mode radar framing structure 404, and the second time interval can be associated with the second active main frame 316-2 of the multi-mode radar framing structure 404, as shown in FIG. 4. In other implementations, the first and second time intervals can be associated with a single active main frame 316 that interleaves the modes 212-1, 212-2, and 212-3.

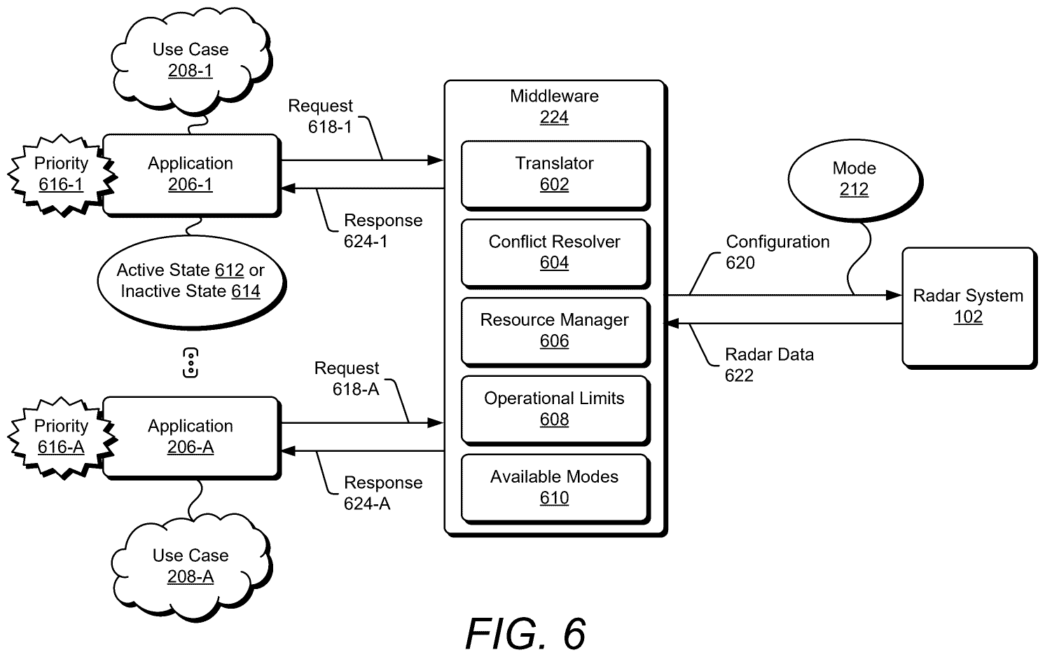

As shown in FIGS. 4 to 5-3, there are a variety of different ways in which the radar system 102 can interleave multiple modes 212 to provide radar sensing for multiple applications 206. The middleware 224 can appropriately configure the radar system 102 for this multi-mode operation based on information provided by multiple applications 206, as further described with respect to FIG. 6.

FIG. 6 illustrates an example middleware 224 for providing radar sensing for multiple applications 206. In the depicted configuration, the middleware 224 is coupled between the applications 206-1 to 206-A and the radar system 102. The middleware 224 includes at least one translator 602, at least one conflict resolver 604, at least one resource manager 606, or some combination thereof. The translator 602, the conflict resolver 604, and the resource manager 606 represent logic that can be implemented in software, firmware, hardware, fixed logic circuitry, or some combination thereof.

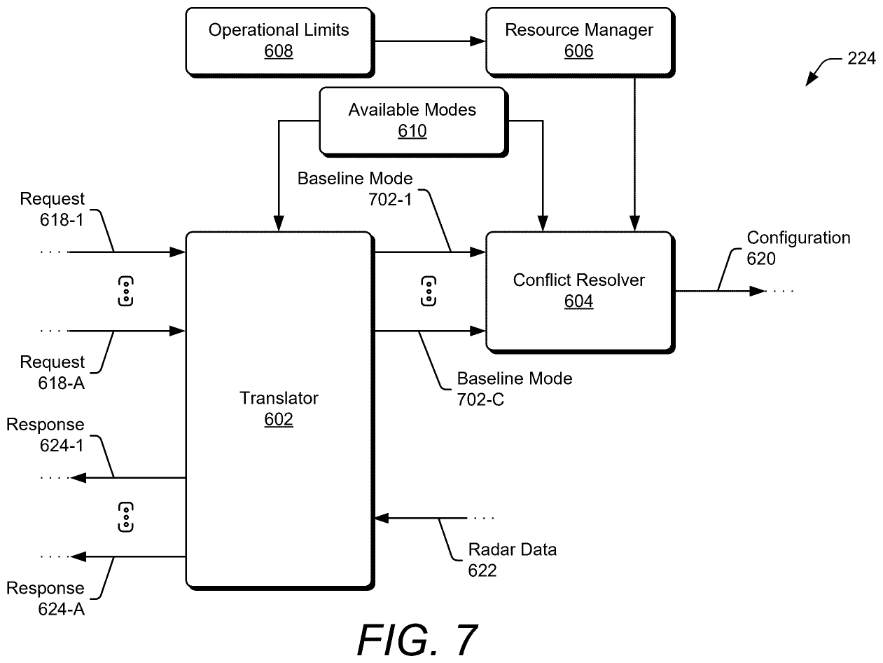

The translator 602 enables the middleware 224 to translate information provided by an application 206 into instructions that can be used to configure the radar system 102. As further described with respect to FIG. 7, the translator 602 can identify one or more modes 212 that can meet the requirements of the application 206 for one or more radar-sensing use cases 208. With the translation services, the middleware 224 enables the radar system 102 to be appropriately configured to provide radar sensing for the application 206 without the application 206 having to understand the design and operational complexities employed by the radar system 102. The translator 602 can also reformat data that is provided by the radar system 102 to an application 206 in a manner that is compatible with or requested by the application 206.

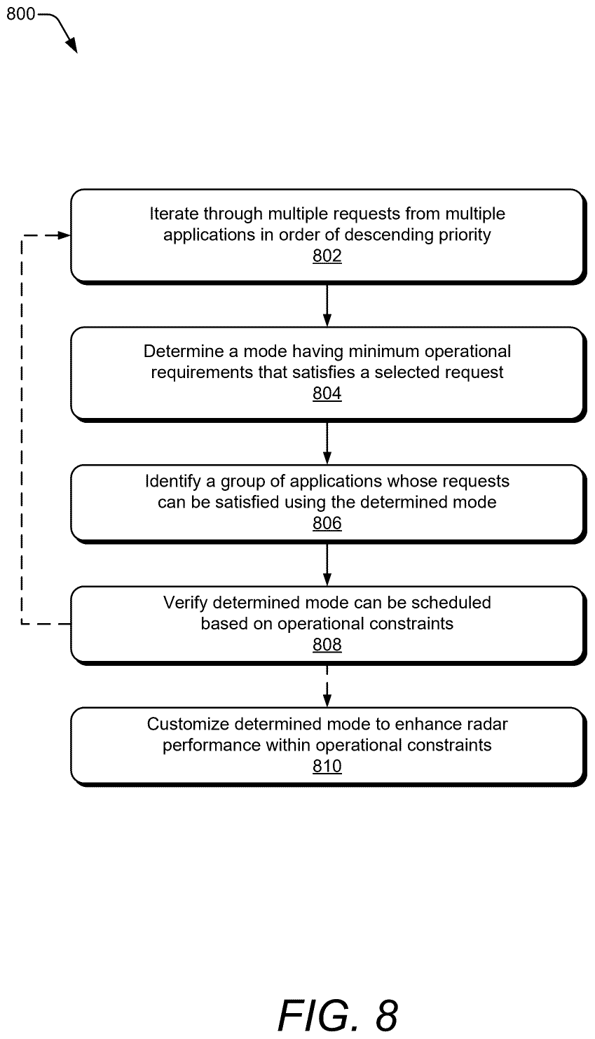

The conflict resolver 604 resolves conflicts between multiple applications 206. To resolve conflicts, the conflict resolver 604 identifies similar radar-sensing requirements across the multiple applications 206 and optimizes a configuration of the radar system 102 (or configurations of multiple radar systems 102) to meet those requirements. In general, the conflict resolver 604 determines which radar system 102 (or multiple radar systems 102) can provide radar sensing for a significant portion of the applications 206. An example decision matrix executed by the conflict resolver 604 is further described with respect to FIG. 8.

The resource manager 606 manages resources of the radar system 102 and/or resources of the computing device 104. Example resources can include power, time, memory, and so forth. The resource manager 606 applies operational constraints, which are taken into account by the translator 602 and/or the conflict resolver 604 for determining the configuration of the radar system 102. In some aspects, the resource manager 606 can limit a quantity of modes 212 and/or limit which of the available modes 610 can be used to configure the radar system 102.

The middleware 224 can optionally include or have access to information regarding operational limits 608 of the radar system 102 and/or the available modes 610 of the radar system 102. The operational limits 608 can be referenced by the resource manager 606 to restrict an operation of the radar system 102. Example operational limits 408 can include frequency band limits, bandwidth limits, transmission power limits, and/or transmission time limits. In some cases, a smaller bandwidth may allow for a longer transmission time limit. The operational limits 608 can be specified in a manner that meets government regulations, such as the Maximum Permitted Exposure (MPE) limit determined by the FCC.

The available modes 610 represent the modes 212-1 to 212-M in which the radar system 102 can operate along with information that defines these modes 212 (e.g., radar performance characteristics, characteristics of an object of interest, and/or characteristics of noise or clutter). The available modes 610 can also include configuration information for generating a radar signal, transmitting the radar signal, receiving the reflected radar signal, and/or processing the reflected radar signal. In some cases, each one of the available modes 610 specifies adjustable characteristics of the radar signal, such as a carrier frequency, a bandwidth, a radar waveform (e.g., a modulation type), a configuration of active antenna elements, and/or a transmit power level. Each of the available modes 610 can also specify a hardware configuration of the radar system 102, a software configuration of the radar system 102, radar-sensing performance of the radar system 102, or some combination thereof. The available modes 610 can include at least one default mode 212. With this information, the middleware 224 can appropriately configure the radar system 102 to operate in accordance with one or more of the available modes 610 to provide radar sensing for multiple applications 206.

During operation, the computing device 104 launches and executes at least two of the applications 206-1 to 206-A having respective use cases 208 for radar sensing. In this example, the application 206-1 can use radar sensing for use case 208-1, and the application 206-A can use radar sensing for use case 208-A. During execution, the application 206 can be in an active state 612 or an inactive state 614 with respect to utilizing radar sensing. The active state 612 indicates that the application 206 is ready to utilize radar data to perform an action associated with the use case 208. In contrast, the inactive state 614 indicates that the application 206 is not ready to utilize radar data. In some situations, the application 206 can be in the inactive state 614 because the use case 208 is disabled, temporarily halted, or awaiting certain conditions to be met.

For applications 206 that can support multiple use cases 208, the active state 612 and the inactive state 614 can be with reference to each use case 208 that is supported. For example, the application 206 can be in an active state 612 with respect to a first use case 208 and can also be in the active state 612 or the inactive state 614 with respect to a second use case 208. A current state of the application 206 can be controlled by the application 206, by the user, by the middleware 224, or some combination thereof.

Each application 206 (or each use case 208) can be associated with a priority 616. For example, the application 206-1 has priority 616-1 and the application 206-A has priority 616-A, which can be similar or different than the priority 616-1. Applications 206 that provide use cases 208 that involve user safety (e.g., collision avoidance), for instance, can have a higher priority compared to other applications 206 that provide use cases 208 that involve a user convenience (e.g., presence detection or gesture recognition). The middleware 224 can consider the priority 616 associated with each application 206 while resolving conflicts and/or configuring the radar system 102, as further described with respect to FIG. 8.

While the computing device 104 executes the application 206, the application 206 can generate a request 618 and provide this request 618 to the middleware 224. For example, the application 206-1 can generate a first request 618-1, and the application 206-A can generate a request 618-A. The request 618 can indicate the state (e.g., the active state 612 or the inactive state 614) of the application 206 and/or a priority 616 associated with the application 206. The request 618 can also specify radar-sensing performance requirements and/or requested radar data formats. In some cases, the radar-sensing performance requirements can indicate the radar performance characteristics, characteristics of an object of interest, and/or characteristics of noise and/or clutter.

In the request 618, the application 206 can specify whether the radar-sensing performance requirement represents a required performance or a desired performance. The required performance represents a minimal or baseline performance level of the radar system 102 that can service the use case 208. In contrast, the desired or optimal performance represents a preferred performance level of the radar system 102 for servicing the radar use 208. For example, the request 618 can indicate a baseline requirement for the radar system 102 to detect objects within a distance of 1 and 8 feet. The request 618 can also indicate a desired requirement for the radar system 102 to detect objects within a distance of 1 and 16 feet. The request 618 can also specify baseline and/or desired performance requirements for other aspects of radar sensing, such as a range of expected velocities of an object of interest, resolution performance of the radar system 102, an update rate, and so forth. In some cases, the request 618 can specify a “best quality of effort” for aspects of radar sensing that are not necessary or critical for the use case 208.

The request 618 can also specify a radar-sensing condition in which the middleware 224 causes the application 206 to transition from the inactive state 614 to the active state 612. Example radar-sensing conditions can include the detection of one or more objects, an object being within a predefined region (e.g., within a maximum distance and/or within a particular angular range), an object having a minimum velocity, or an object having a particular characteristics (e.g., a particular radar-cross section or a particular material composition).

In the context of providing radar sensing for multiple applications 206, at least two of the applications 206 are in the active state 612 during a same time interval. The middleware 224 generates a configuration 620 based on the multiple requests 618. The configuration 620 can specify one or more modes 212 in which the radar system 102 is to operate. In some cases, the configuration 620 can define aspects of the radar framing structure 314 to enable the radar system 102. For example, the configuration 620 can specify a type of single-mode radar framing structure 402, a type of multi-mode radar framing structure 404, or any of the radar framing structures 314 described with respect to FIGS. 5-1 to 5-3. Alternatively, the radar system 102 can automatically determine the radar framing structure 314 based on the one or more modes 212 specified as part of the configuration 620. The radar system 102 receives this configuration 620 and operates accordingly. The configuration 620 can also specify a hardware and/or a software configuration. For example, the configuration 620 can indicate a quantity of antennas and/or a configuration of the antennas that is necessary to satisfy the request 618. Additionally or alternatively, the configuration 620 can indicate a type of processing that is necessary to satisfy the request 618.

The radar system 102 generates radar data 622 while operating in accordance with the configuration 620. The middleware 224 passes the radar data 622 to one or more of the applications in the form of a response 624. For example, the middleware 224 generates a first response 624-1 for the application 206-1 and another response 624-A for the application 206-A, both of which can include at least some portion of the radar data 622. The radar data 622 can include raw or minimally processed data (e.g., raw digital samples of the radar receive signal 308 or data representative of range-Doppler maps) or processed data (e.g., an indication of which gesture is detected, an indication that one or more users are present, or an indication of a potential collision).

In some situations, the response 624 can trigger the application 206 to transition from the inactive state 614 to the active state 612. Consider an example in which the application 206-1 supports a sleep-sensing use case 208. To support the sleep-sensing use case 208, the application 206-1 processes radar data 622 to determine whether a user is asleep and/or to determine a quality of the user's sleep. Sleep sensing is not applicable until the user is detected or within a predetermined range associated with sleep sensing. To save power and facilitate radar sensing for multiple applications 206, the application 206 may be in the inactive state 614 until the radar system 102 detects the presence of the user. The application 206-1 sends a request 618 that instructs the middleware 224 to send a response 624-1 that causes the application 206-1 to transition to the active state 612 responsive to the radar system 102 determining that the user is present (e.g., within a certain distance for sleep sensing). As another example, another application 206-A that supports a gesture-recognition use case 208-A may be in the inactive state 614 until the middleware 224 sends a response 624-A that indicates that the user is within a maximum distance for gesture sensing. In yet another example, an application 206 may be in the inactive state 614 until the middleware 224 sends a response 624 that indicates the detection of motion by the radar system 102. By enabling the middleware 224 to “wake-up” an application 206 via a response 624, the application 206 can be in the inactive state 614 for a period of time until the requested condition occurs. This enables the computing device 104 to conserve power and reduces the quantity of applications 206 that need radar sensing in a given time, which reduces a complexity associated with resolving conflicts.

The middleware 224 can also manage how often the configuration 620 of the radar system 102 changes. If an application 206-1 transitions from the active state 612 to the inactive state 614, the middleware 224 may delay determining a new configuration 620 of the radar system 102 until a predetermined amount of time has passed to increase confidence that the application 206 will not readily transition back from the inactive state 614 to the active state 612. The operation of the middleware 224 is further described with respect to FIG. 7.

FIG. 7 illustrates an example scheme implemented by the middleware 224 for providing radar sensing for multiple applications 206. In the depicted configuration, the translator 602 is coupled to the conflict resolver 604. The conflict resolver 604 is also coupled to the resource manager 606.

During operation, the translator 602 of the middleware 224 identifies, from the list of available modes 610, baseline modes 702-1 to 702-C of the radar system 102 that can satisfy the requests 618-1 to 618-A provided by the applications 206-1 to 206-A. The variable C represents a positive integer that may or may not be equal to A. In some cases, the translator 602 provides one baseline mode 702 for each request 618, and the baseline mode 702 represents one of the available modes 610 that meets the baseline performance specified by the request 618. In other cases, the translator 602 can provide multiple baseline modes 702 for at least some of the requests 618. The multiple baseline modes 702 can include one of the available modes 610 that meets the baseline performance specified by the request 618 as well as at least another one of the available modes 610 that exceeds the baseline performance specified by the request 618.

The conflict resolver 604 determines the configuration 620 of the radar system based on the baseline modes 702-1 to 702-C provided by the translator 602. The conflict resolver 604 also resolves any conflicts between multiple applications 206 to optimize performance of the radar system 102 and enable radar sensing to be provided for at least a subset of the multiple applications 206 that are in the active state 612. The resource manager 606 provides the conflict resolver 604 information based on the operational limits 608 to ensure the configuration 620 determined by the conflict resolver 604 is in compliance with the operational limits 608 and general resource management constraints of the computing device 104 and/or of the radar system 102.

In some situations, the translator 602 can reformat the radar data 622 prior to passing the radar data 622 to the application 206 via the responses 624-1 to 624-A. The translator 602, for instance, can upsample or downsample the radar data 622 to provide the radar data 622 to each application 206 at a requested sampling rate. The middleware 224 can also handle distributing the radar data 622 to the appropriate applications 206. For example, the translator 602 can pass a portion of the radar data 622 that is associated with the first mode 212-1 to one or more applications 206 having requests 618 that are satisfied by the first mode 212-1. The translator 602 can also pass another portion of the radar data 622 that is associated with the second mode 212-2 to one or more other applications 206 having requests 618 that are satisfied by the second mode 212-2.

Furthermore, the translator 602 can format the radar data 622 in a manner that enables an application 206 to process the radar data 622 as the radar system 102 operates in accordance with different configurations 620 (or different modes 212). Consider an example in which an application 206 desires a first range resolution, which can be realized by providing radar data 622 having a first quantity of range bins. The middleware 224, however, determines a configuration 620 of the radar system 102 that can realize a second range resolution, which is of lower resolution than the first range resolution. In this case, the configuration 620 can generate radar data 622 having a second quantity of range bins that is less than the first quantity of range bins. Although this current configuration 620 of the radar system 102 does not satisfy the requested range resolution of the application 206, the configuration 620 of the radar system 102 can change in the future as different combinations of applications 206 are in the active state 612 and the conflict resolver 604 updates the configuration 620.

While the radar system 102 generates the radar data 622 in accordance with the configuration 620, the middleware 224 uses the translator 602 to upscale the radar data 622 for the application 206. In this case, radar data 622 is duplicated across the second quantity of range bins to provide an upscaled version of the radar data 622 that has the first quantity of range bins. Although this can utilize additional computational resources, it simplifies the processing for the application 206 as the application 206 does not have to know the resolution of the radar data 622 or does not have to support multiple data formats. Furthermore, no additional changes are needed by the application 206 to handle the situation in which the middleware 224 later updates the configuration 620 to support the higher first range resolution.

In some cases, the application 206 can be designed to be insensitive or agnostic to changes in the radar data 622 as caused by changes in the configuration 620 of the radar system 102. In some cases, the application 206 can utilize a machine-learned model to process radar data 622 of various levels of interpolation so that the application 206 can be robust against changes in the radar data 622. Optionally, the middleware 224 can provide the radar data 622 directly to the application without performing additional steps to reformat the radar data 622. In addition to providing the radar data 622, the middleware 224 can indicate in the response 624 when the configuration 620 of the radar system 102 changes so that the application 206 can avoid false positives associated with motion or movement.

As seen in FIGS. 6 and 7, the middleware 224 acts as a mediator between the applications 206-1 to 206-A and the radar system 102. By translating requests 618, resolving conflicts between multiple applications 206, and/or managing resources of the radar system 102 and/or the computing device 104, the middleware 224 can appropriately configure the radar system 102 to service multiple applications 206 and provide the requested radar data 622 to the applications 206-1 to 206-A to support the radar-sensing use cases 208-1 to 208-A. An operation of the conflict resolver 604 is further described with respect to FIG. 8.

FIG. 8 illustrates an example flow diagram 800 for resolving conflicts between multiple applications 206. The steps of the flow diagram 800 can generally be performed by the middleware 224, including the conflict resolver 604. At 802, the conflict resolver 604 iterates through multiple requests 618-1 to 618-A from multiple applications 206-1 to 206-A in order of descending priority 616. For example, the conflict resolver 604 first evaluates a request 618 from an application 206 associated with a highest priority 616, and next evaluates a request 618 from an application 206 associated with a second highest priority 616.

In this flow diagram 800, the conflict resolver 604 is determining a configuration 620 of the radar system 102. As such, the requests 618 that the conflict resolver 604 iterates through can include requests 618 from applications 206 that are in the active state 612. For determining the configuration 620, the conflict resolver 604 can temporarily ignore or discard requests 618 associated with applications 206 that are in the inactive state 614.

At 804, the middleware 224 determines a mode 212 having minimum operational requirements that satisfy the selected request 618. The determined mode 212 can be one of the baseline modes 702 provided by the translator 602. At this step, the conflict resolver 604 determines a lowest quality setting of the radar system 102 that can satisfy the selected request 618.

At 806, the conflict resolver 604 identifies a group of applications 206 whose requests 618 can be satisfied using the determined mode 212. For example, the conflict resolver 604 can identify one, two, three, or more other applications 206 whose requests 618 can also be satisfied using the mode 212 determined at 804. This enables the resources of the radar system 102 to be efficiently utilized while providing radar sensing for multiple applications 206.

At 808, the conflict resolver 604 verifies that the determined mode 212 can be scheduled based on the operational constraints provided by the resource manager 606. For example, the conflict resolver 604 can verify that the determined mode 212 can be scheduled within at least one of the active main frames 316 of a single-mode radar framing structure 402 or a multi-mode radar framing structure 404. The conflict resolver 604 can also verify that the operational constraints (e.g., the operational limits 608) provided by the resource manager 606 are satisfied.

This process can repeat at 802 for other requests that have yet to be satisfied. While iterating through 802 to 808 again, the conflict resolver 604 can determine a second mode 212 that can satisfy other requests 618 associated with a second group of the applications 206. In some cases, the conflict resolver 604 can determine that an aspect of the previously determined mode 212 can be adjusted (e.g., a different mode 212 of the available modes 610 can be selected) to service a larger group of applications 206 (e.g., the previous group of applications and the current group of the applications).

The conflict resolver 604 can also determine that one or more of the applications 206 cannot be serviced at this time due to the corresponding baseline mode 702 not being able to be scheduled within an active main frame or within the operational constraints. In this case, the middleware 224 can send a response 624 to the application 206 to indicate that radar sensing is currently unavailable.

After iterating through the multiple requests, the conflict resolver 604 can optionally customize (or update) the one or more determined modes 212 to enhance radar performance within the operational constraints, as described at 810. For example, the conflict resolver 604 can change certain parameters of the determined mode 212 or select a different mode 212 from the available modes 610 that meets the minimal performance provided by the determined mode 212 and further provides additional performance in terms of resolution or update rate while satisfying the operational constraints. This enables the conflict resolver 604 to determine a configuration 620 that can meet some of the desired performance metrics requested by the applications 206.

In general, the conflict resolver 604 can continue to iterate through the multiple requests to determine a configuration 620 (e.g., one or more modes 212) that can service a substantial portion of the requests from applications 206 that are in the active state 612. Although not explicitly shown in the flow diagram 800, the conflict resolver 604 can also perform these steps to configure radar systems 102 in a similar or different manner. With multiple radar systems 102 available, the computing device 104 is more likely to be able to provide radar sensing to a larger quantity of the applications 206.

### Example Method

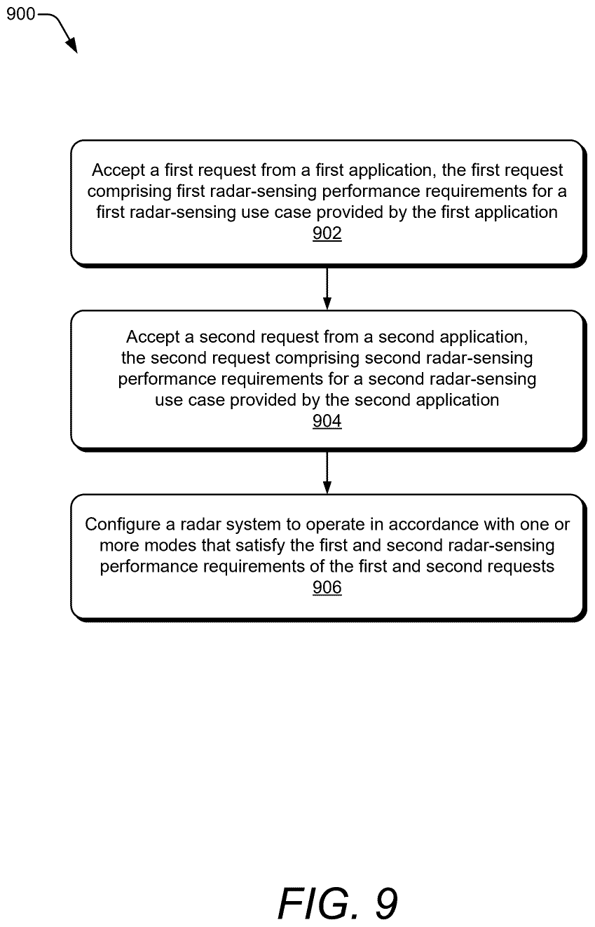

FIG. 9 depicts an example method 900 performed by middleware 224 to provide radar sensing for multiple applications 206. Method 900 is shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100-1 to 100-6 of FIG. 1, and entities detailed in FIG. 2-1, 2-2, 3-1, or 4, reference to which is made for example only. The techniques are not limited to performance by one entity or multiple entities operating on one device.

At 902, a first request is accepted from a first application. The first request comprises first radar-sensing performance requirements for a first radar-sensing use case provided by the first application. For example, the middleware 224 accepts the first request 618-1 from the first application 206-1. The first request 618-1 includes first radar-sensing performance requirements for a first radar-sensing use case (e.g., use case 208-1), which is provided by (or supported by) the first application 206-1.

At 904, a second request is accepted from a second application. The second request comprises second radar-sensing performance requirements for a second radar-sensing use case provided by the second application. For example, the middleware 224 accepts the request 618-A from the application 206-A. The request 618-A includes second radar-sensing performance requirements for a second radar-sensing use case (e.g., use case 208-A), which is provided by (or supported by) the application 206-A.

The first and second radar-sensing performance requirements can each include at least one radar-performance metric. The radar-performance metric can include a radar performance characteristic, a characteristic of an object of interest, and/or a characteristic of noise or clutter. The requests 618-1 and 618-A can also include priorities 616-1 and 616-A and/or indications of whether the corresponding applications 206-1 and 206-A are in the active state 612 or the inactive state 614.

At 906, a radar system is configured to operate in accordance with one or more modes that satisfy the first and second radar-sensing performance requirements of the first and second requests. For example, the middleware 224 configures the radar system 102 to operate in accordance with one or more modes 212 that satisfy the first and second radar-sensing performance requirements. In some cases, the one or more modes 212 can include a single mode 212. In other cases, the one or more modes 212 can include at least two different modes 212, which are scheduled in accordance with the single-mode radar framing structure 402 or the multi-mode radar framing structure 404.

### Example Computing System

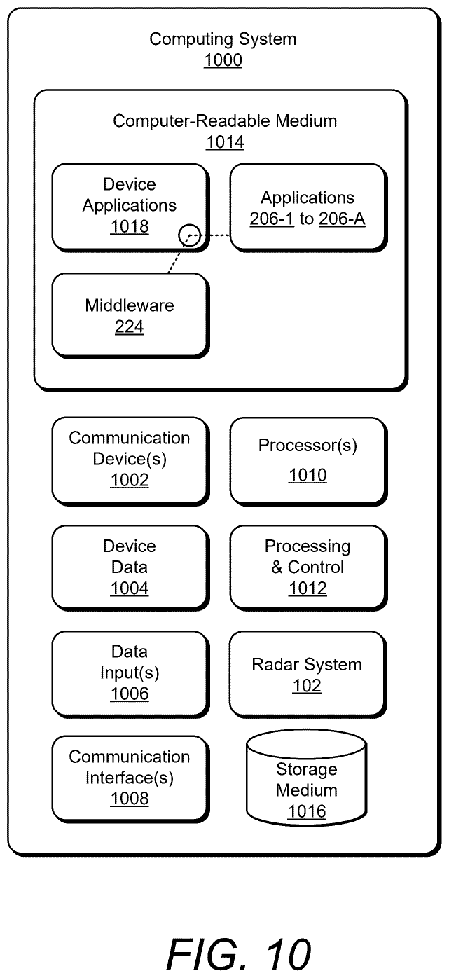

FIG. 10 illustrates various components of an example computing system 1000 that can be implemented as any type of client, server, and/or computing device as described with reference to the previous FIGS. 2-1 and 2-2 to provide radar sensing for multiple applications 206.

The computing system 1000 includes communication devices 1002 that enable wired and/or wireless communication of device data 1004 (e.g., received data, data that is being received, data scheduled for broadcast, or data packets of the data). The communication devices 1002 or the computing system 1000 can include one or more radar systems 102. The device data 1004 or other device content can include configuration settings of the device, media content stored on the device, and/or information associated with a user of the device. Media content stored on the computing system 1000 can include any type of audio, video, and/or image data. The computing system 1000 includes one or more data inputs 1006 via which any type of data, media content, and/or inputs can be received, such as human utterances, user-selectable inputs (explicit or implicit), messages, music, television media content, recorded video content, and any other type of audio, video, and/or image data received from any content and/or data source.

The computing system 1000 also includes communication interfaces 1008, which can be implemented as any one or more of a serial and/or parallel interface, a wireless interface, any type of network interface, a modem, and as any other type of communication interface. The communication interfaces 1008 provide a connection and/or communication links between the computing system 1000 and a communication network by which other electronic, computing, and communication devices communicate data with the computing system 1000.

The computing system 1000 includes one or more processors 1010 (e.g., any of microprocessors, controllers, and the like), which process various computer-executable instructions to control the operation of the computing system 1000. Alternatively or in addition, the computing system 1000 can be implemented with any one or combination of hardware, firmware, or fixed logic circuitry that is implemented in connection with processing and control circuits which are generally identified at 1012. Although not shown, the computing system 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1000 also includes a computer-readable medium 1014, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 1000 can also include a mass storage medium device (storage medium) 1016.

The computer-readable medium 1014 provides data storage mechanisms to store the device data 1004, as well as various device applications 1018 and any other types of information and/or data related to operational aspects of the computing system 1000. For example, an operating system can be maintained as a computer application with the computer-readable medium 1014 and executed on the processors 1010. The device applications 1018 may include a device manager, such as any form of a control application, software application, signal-processing and control module, code that is native to a particular device, a hardware abstraction layer for a particular device, and so on.

The device applications 1018 also include any system components, engines, or managers to implement aspects of providing radar sensing for multiple applications 206-1 to 206-A. In this example, the device applications 1018 includes the applications 206-1 to 206-A and the middleware 224 of FIG. 2-1.

### CONCLUSION

Although techniques using, and apparatuses including, means of providing radar sensing for multiple applications have been described in language specific to features and/or methods, it is to be understood that the subject of the appended claims is not necessarily limited to the specific features or methods described. Rather, the specific features and methods are disclosed as example implementations of providing radar sensing for multiple applications.

Some examples are provided below.

Example 1: A method performed by middleware, the method comprising:
accepting a first request from a first application, the first request comprising first radar-sensing performance requirements for a first radar-sensing use case provided by the first application;
accepting a second request from a second application, the second request comprising second radar-sensing performance requirements for a second radar-sensing use case provided by the second application; and
configuring a radar system to operate in accordance with one or more modes that satisfy the first and second radar-sensing performance requirements of the first and second requests.

Example 2: The method of example 1, further comprising:
receiving radar data from the radar system based on the radar system operating in accordance with the one or more modes;
passing at least a first portion of the radar data to the first application based on the first request; and
passing at least a second portion of the radar data to the second application based on the second request.

Example 3: The method of example 1 or 2, wherein:
the first radar-sensing performance requirements differ from the second radar-sensing performance requirements; and
the method further comprises:
   determining a first mode of the one or more modes that satisfies the first and second radar-sensing performance requirements; and
   configuring the radar system to operate in accordance with the first mode.

Example 4: The method of example 1 or 2, wherein:
the first radar-sensing performance requirements differ from the second radar-sensing performance requirements; and
the method further comprises:
   determining a first mode of the one or more modes that satisfies the first radar-sensing performance requirements;
   determining a second mode of the one or more modes that satisfies the second radar-sensing performance requirements; and
   configuring the radar system to operate in accordance with the first mode and the second mode.

Example 5: The method of example 4, wherein the configuring of the radar system to operate in accordance with the first mode and the second mode comprises interleaving active radar frames associated with the first mode with active radar frames associated with the second mode.

Example 6: The method of example 5, wherein the interleaving comprises alternating between scheduling the active radar frames associated with the first mode and the active radar frames associated with the second mode in accordance with a pulse-mode feature frame.

Example 7: The method of example 5, wherein the interleaving of the radar frames comprises alternating between scheduling a set of multiple active radar frames associated with the first mode and a set of multiple active radar frames associated with the second mode in accordance with a burst-mode feature frame.

Example 8: The method of any previous example, further comprising:
accepting a third request from a third application, the third request comprising third radar-sensing performance requirements for a third radar-sensing use case provided by the third application; and
configuring the radar system to operate in accordance with one or more other modes that satisfy the first, second, and third requests.

Example 9: The method of any previous example, wherein the configuring of the radar system comprises configuring multiple radar systems to operate in accordance with the one or more of the modes to satisfy the first and second requests.

Example 10: A method performed by middleware that is coupled between a radar system and multiple applications, the method comprising:
receiving multiple requests from the multiple applications, each application of the multiple applications capable of being in an active state or an inactive state with regard to utilizing radar sensing provided by the radar system; and
dynamically configuring the radar system to operate in accordance with at least one mode to provide radar sensing for a set of the multiple applications that are in the active state, the at least one mode satisfying a set of the multiple requests that correspond with the set of the multiple applications.

Example 11: The method of example 10, further comprising:
determining that a different set of the multiple applications are in the active state; and
reconfiguring the radar system to operate in accordance with at least one updated mode to provide radar sensing for the different set of the multiple applications, the at least one updated mode satisfying a different set of the multiple requests that correspond with the different set of the multiple applications.

Example 12: The method of example 11, wherein:
the determining comprises determining that an application of the set of the multiple applications transitioned from the active state to the inactive state; and
the method further comprises waiting a predetermined amount of time before reconfiguring the radar system.

Example 13: The method of any one of examples 10 to 12, further comprising:
translating the set of the multiple requests into baseline modes that are supported by the radar system; and
determining the at least one mode based on the baseline modes.

Example 14: The method of example 13, wherein the determining of the at least one mode comprises:
iterating through the set of the multiple requests;
determining a mode of the baseline modes, the mode having minimum operational requirements that satisfy a request of the set of the multiple requests;
identifying a subset of the multiple applications having requests that can be satisfied using the determined mode; and
verifying that the determined mode can be scheduled based on operational constraints of the radar system.

Example 15: The method of example 14, wherein:
each request of the set of the multiple requests is associated with a priority; and
the iterating through the set of the multiple requests comprises iterating through the set of the multiple requests in order of descending priority.

Example 16: The method of example 14 or 15, further comprising:
after iterating through the set of the multiple requests, updating the determined mode to enhance a performance of the radar system within the operational constraints.

Example 17: The method of any one of examples 14 to 16, further comprising:
determining another subset of the multiple applications having requests that cannot be satisfied using the at least one mode; and
sending at least one response to the other subset of the multiple applications to indicate that radar sensing is currently not available.

Example 18: The method of any one of examples 10 to 17, further comprising:
receiving a request of the multiple requests from an application of the multiple applications that is in the inactive state, the request indicating a condition for the application to transition to the active state;
receiving radar data from the radar system based on the radar system operating in accordance with the at least one mode; and
causing the application to transition from the inactive state to the active state responsive to the radar data indicating occurrence of the condition.

Example 19: An apparatus comprising:
the middleware configured to perform any one of the methods of examples 1-18.

Example 20: A computer-readable storage medium comprising instructions that, responsive to execution by a processor, cause the middleware to perform any one of the methods of examples 1-18.

1. A method performed by middleware, the method comprising:
accepting a first request from a first application, the first request comprising first radar-sensing performance requirements for a first radar-sensing use case provided by the first application;
accepting a second request from a second application, the second request comprising second radar-sensing performance requirements for a second radar-sensing use case provided by the second application; and
configuring a radar system to operate in accordance with one or more modes that satisfy the first and second radar-sensing performance requirements of the first and second requests.

2. The method of claim 1, further comprising:
receiving radar data from the radar system based on the radar system operating in accordance with the one or more modes;
passing at least a first portion of the radar data to the first application based on the first request; and
passing at least a second portion of the radar data to the second application based on the second request.

3. The method of claim 1, wherein:
the first radar-sensing performance requirements differ from the second radar-sensing performance requirements; and
the method further comprises:
determining a first mode of the one or more modes that satisfies the first and second radar-sensing performance requirements; and
configuring the radar system to operate in accordance with the first mode.

4. The method of claim 1, wherein:
the first radar-sensing performance requirements differ from the second radar-sensing performance requirements; and
the method further comprises:
determining a first mode of the one or more modes that satisfies the first radar-sensing performance requirements;
determining a second mode of the one or more modes that satisfies the second radar-sensing performance requirements; and
configuring the radar system to operate in accordance with the first mode and the second mode.

5. The method of claim 4, wherein the configuring of the radar system to operate in accordance with the first mode and the second mode comprises interleaving active radar frames associated with the first mode with active radar frames associated with the second mode.

6. The method of claim 5, wherein the interleaving comprises alternating between scheduling the active radar frames associated with the first mode and the active radar frames associated with the second mode in accordance with a pulse-mode feature frame.

7. The method of claim 5, wherein the interleaving of the radar frames comprises alternating between scheduling a set of multiple active radar frames associated with the first mode and a set of multiple active radar frames associated with the second mode in accordance with a burst-mode feature frame.

8. The method of claim 1, further comprising:
accepting a third request from a third application, the third request comprising third radar-sensing performance requirements for a third radar-sensing use case provided by the third application; and
configuring the radar system to operate in accordance with one or more other modes that satisfy the first, second, and third requests.

9. The method of claim 1, wherein the configuring of the radar system comprises configuring multiple radar systems to operate in accordance with the one or more of the modes to satisfy the first and second requests.

10. A method performed by middleware that is coupled between a radar system and multiple applications, the method comprising:
receiving multiple requests from the multiple applications, each application of the multiple applications capable of being in an active state or an inactive state with regard to utilizing radar sensing provided by the radar system; and
dynamically configuring the radar system to operate in accordance with at least one mode to provide radar sensing for a set of the multiple applications that are in the active state, the at least one mode satisfying a set of the multiple requests that correspond with the set of the multiple applications.

11. The method of claim 10, further comprising:
determining that a different set of the multiple applications are in the active state; and
reconfiguring the radar system to operate in accordance with at least one updated mode to provide radar sensing for the different set of the multiple applications, the at least one updated mode satisfying a different set of the multiple requests that correspond with the different set of the multiple applications.

12. The method of claim 11, wherein:
the determining comprises determining that an application of the set of the multiple applications transitioned from the active state to the inactive state; and
the method further comprises waiting a predetermined amount of time before reconfiguring the radar system.

13. The method of claim 10, further comprising:
translating the set of the multiple requests into baseline modes that are supported by the radar system; and
determining the at least one mode based on the baseline modes.

14. The method of claim 13, wherein the determining of the at least one mode comprises:
iterating through the set of the multiple requests;
determining a mode of the baseline modes, the mode having minimum operational requirements that satisfy a request of the set of the multiple requests;
identifying a subset of the multiple applications having requests that can be satisfied using the determined mode; and
verifying that the determined mode can be scheduled based on operational constraints of the radar system.

15. The method of claim 14, wherein:
each request of the set of the multiple requests is associated with a priority; and
the iterating through the set of the multiple requests comprises iterating through the set of the multiple requests in order of descending priority.

16. The method of claim 14, further comprising:
after iterating through the set of the multiple requests, updating the determined mode to enhance a performance of the radar system within the operational constraints.

17. The method of claim 14, further comprising:
determining another subset of the multiple applications having requests that cannot be satisfied using the at least one mode; and
sending at least one response to the other subset of the multiple applications to indicate that radar sensing is currently not available.

18. The method of claim 10, further comprising:
receiving a request of the multiple requests from an application of the multiple applications that is in the inactive state, the request indicating a condition for the application to transition to the active state;
receiving radar data from the radar system based on the radar system operating in accordance with the at least one mode; and
causing the application to transition from the inactive state to the active state responsive to the radar data indicating occurrence of the condition.

19. A computer-readable storage medium comprising instructions that, responsive to execution by a processor, implement middleware configured to:
accept a first request from a first application, the first request comprising first radar-sensing performance requirements for a first radar-sensing use case provided by the first application;
accept a second request from a second application, the second request comprising second radar-sensing performance requirements for a second radar-sensing use case provided by the second application; and
configure a radar system to operate in accordance with one or more modes that satisfy the first and second radar-sensing performance requirements of the first and second requests.

20. The computer-readable storage medium of claim 19, wherein the middleware is configured to:
determine a first mode of the one or more modes that satisfies the first and second radar-sensing performance requirements, the first radar-sensing performance requirements being different from the second radar-sensing performance requirements; and
configure the radar system to operate in accordance with the first mode.
